(19) United States
(12) Patent Application Publication
(10) Pub. No.: US 2004/0148868 A1
(43) Pub. Date: Aug. 5, 2004

(54) Methods of making ceramics

(75) Inventors: Thomas J. Anderson, Woodbury, MN (US); Ahmet Celikkaya, Woodburt, MN (US); Anatoly Z. Rosenflanz, Maplewood, MN (US); Donna W. Bange, Eagan, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/358,765

(22) Filed: Feb. 5, 2003

(51) Int. Cl. C01F 7/04; C09C 1/68

(52) U.S. Cl. 51/308; 423/600; 51/309

(57) ABSTRACT

Methods of making ceramics, including ceramic abrasive particles, comprising alumina (in some embodiments, alpha alumina). The ceramic abrasive particles can be incorporated into a variety of abrasive articles, including bonded abrasives, coated abrasives, nonwoven abrasives, and abrasive brushes.

### BACKGROUND

There are numerous processes known in the ceramics art to prepare dense (including up to 100 percent dense), polycrystalline, alumina-containing (including up to 100 percent by weight alumina ceramics. In one example of such processes the raw materials are heated above their melting point and then cooled to provide a fused product. The resulting ceramics are typically dense, but contain large alpha-alumina crystal on the order of several hundred micrometers. Fused alumina ceramics containing smaller crystals can be made by increasing the cooling rates, but the alumina crystal sizes still remain over several micrometers (typically 5-15 micrometers).

In another example, ceramics having compositions near alumina-zirconia eutectic compositions are prepared by melting and then rapidly cooling the melts. The resulting ceramics typically have high density and fine eutectic microstructure within domains that are well over 10 micrometers in size. The domains are separated by domain boundaries comprising impurities and coarser microcrystalline features. Furthermore, both the domain sizes and the eutectic structure contained within them are typically non-uniform. The material properties tend to be limited by the size of these domains, nonuniformity and coarseness of microstructural features, and impurities.

In another example, an alumina precursor is sintered at temperatures less than the melting temperature to form a dense polycrystalline ceramic body. The alumina precursor may be an alumina powder (e.g.,alpha, or transitional alumina powder(s)) or an alpha alumina precursor (e.g., hydrated aluminas such as boehmite) that is sintered to form the dense polycrystalline alumina ceramic.

In many ceramic applications (e.g., for abrasive materials), it is generally desired for the ceramic material to have a density of at least 90 (or more) percent of the theoretical density, and comprise fine (desirably less than 10, 5, 1, 0.5 or even less than 0.25 micrometer) crystals (e.g., alpha alumina crystals). In general, it is known in the ceramics art that dense ceramics comprising finer crystalline structures tend to have improved properties (e.g., hardness, toughness, and strength). However, achieving desired fine crystallite sizes, while at the same time obtaining a high degree of density can be difficult. Typically, conditions (sintering time and temperature) promoting higher density ceramic materials also promote growth of the crystallites. To overcome this problem, most ceramic processes start with very fine raw material powders, employ a low sintering temperature and short sintering times together with the application of significant amounts of pressure (as is the case with hot pressing and hot isostatic pressing) on the green bodies during sintering. The use of such fine powders and high pressure processing tend to be expensive and less convenient than using conventional raw material powders and processing at or near atmospheric pressure.

### SUMMARY

The present invention provides a method for making ceramics comprising alumina (in some embodiments, alpha alumina).

In one exemplary embodiment, the present invention provides a method for making ceramic, the method comprising heating a precursor material up to 1250° C. (in some embodiments up to 1225° C., 1200° C., 1175° C., 1150° C., 1125° C., or even up to 1100° C.) for up to 1 hour (in some embodiments up to 45 minutes, 30 minutes, 25 minutes, 20 minutes, 15 minutes, 10 minutes, or even less than 5 minutes) under pressure not greater than 500 atmospheres (in some embodiments, not greater than 250 atmospheres, 200 atmospheres, 100 atmospheres, 75 atmospheres, 50 atmospheres, 25 atmospheres, 10 atmospheres, 5 atmospheres, 4 atmospheres, 3 atmospheres, 2 atmospheres, 1.5 atmosphere, 1.25 atmosphere, 1.05 atmosphere, or even at about 1 atmosphere (i.e., the pressure at the earth's surface) or even under vacuum to provide a ceramic comprising at least 35 (in some embodiments, at least 40, 45, 50, 55, 60, 65, 70, 75, 80, 85, or even at least 90) percent by weight Al₂O₃ (in some embodiments, alpha Al₂O₃), based on the total weight of the ceramic, wherein the ceramic has a density of at least 90 (in some embodiments at least 95, 97, 98, or even at least 99) percent of theoretical density, wherein the ceramic has an average hardness of at least 15 GPa (in some embodiments, at least 16 GPa, 17 GPa, 18 GPa, or even at least 19 GPa), and wherein the precursor material does not contain alpha Al₂O₃, alpha Al₂O₃ nucleating agent, or alpha Al₂O₃ nucleating agent equivalent. Typically, the precursor material has a Tₓ, wherein the heating is conducted at at least one temperature that is at least 50° C. greater than (in some embodimdents, at least 75° C. greater than, or even at least 100° C. greater than) the Tₓ. In some embodiments, the precursor material has an average hardness not more than 10 GPa (in some embodiments, not more than 9 GPa, 8 GPa, 7 GPa, 6 GPa, 5 GPa, or even not more than 4 GPa). In some embodiments, at least 80, 85, 90, 95, 97, 98, 99, 100 percent by volume of the ceramic is crystalline, based on the total volume of the ceramic. In some embodiments comprising alpha Al₂O₃, the alpha Al₂O₃ has an average crystal size not greater than 150 nanometers (in some embodiments, not greater than 100 nanometers). In some embodiments, the ceramic further comprises a metal oxide other than Al₂O₃ (e.g., REO, Y₂O₃, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof).

In another exemplary embodiment, the present invention provides a method for making ceramic, the method comprising heating a precursor material up to 1250° C. (in some embodiments up to 1225° C., 1200° C., 1175° C., 1150° C., 1125° C., or even up to 1100° C.) for up to 1 hour (in some embodiments up to 45 minutes, 30 minutes, 25 minutes, 20 minutes, 15 minutes, 10 minutes, or even less than 5 minutes) under pressure not greater than 500 atmospheres (in some embodiments, not greater than 250 atmospheres, 200 atmospheres, 100 atmospheres, 75 atmospheres, 50 atmospheres, 25 atmospheres, 10 atmospheres, 5 atmospheres, 4 atmospheres, 3 atmospheres, 2 atmospheres, 1.5 atmosphere, 1.25 atmosphere, 1.05 atmosphere, or even at about 1 atmosphere (i.e., the pressure at the earth's surface) or even under vacuum to provide a ceramic comprising at least 35 (in some embodiments, at least 40, 45, 50, 55, 60, 65, 70, 75, 80, 85, or even at least 90) percent by weight Al₂O₃, based on the total weight of the ceramic, wherein the alpha Al₂O₃ has an average crystal size not greater than 150 nanometers (in some embodiments, not greater than 100 nanometers), wherein the ceramic has a density of at least 90 (in some embodiments at least 95, 97, 98, or even at least 99) percent of theoretical density, wherein the ceramic has an average hardness of at least 15 GPa (in some embodiments, at least 16 GPa, 17 GPa, 18 GPa, or even at least 19 GPa), and wherein the precursor material contains not more than 30 (in some embodiments, not more than 25, 20, 15, 10, 5, or even zero) percent by volume crystalline material, based on the total volume of the precursor material, and wherein the precursor material has a density of at least 70 (in some embodiments, at least 75, 80, 85, 90, 95, 96, 97, 98, 99, or even 100) percent of theoretical density of the precursor material. Typically, the precursor material has a Tₓ, wherein the heating is conducted at at least one temperature that is at least 50° C. greater than (in some embodimdents, at least 75° C. greater than, or even at least 100° C. greater than) Tₓ. In some embodiments, the precursor material has an average hardness not more than 10 GPa (in some embodiments, not more than 9 GPa, 8 GPa, 7 GPa, 6 GPa, 5 GPa, or even not more than 4 GPa). In some embodiments, at least 80, 85, 90, 95, 97, 98, 99, 100 percent by volume of the ceramic is crystalline, based on the total volume of the ceramic. In some embodiments, the ceramic further comprises a metal oxide other than Al₂O₃ (e.g., REO, Y₂O₃, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof).

Some embodiments of ceramics made according to a method of the present invention can be made, formed as, or converted into beads (e.g., beads having diameters of at least 1 micrometers, 5 micrometers, 10 micrometers, 25 micrometers, 50 micrometers, 100 micrometers, 150 micrometers, 250 micrometers, 500 micrometers, 750 micrometers, 1 mm, 5 mm, or even at least 10 mm), articles (e.g., plates), fibers, particles, and coatings (e.g., thin coatings). The beads can be useful, for example, in reflective devices such as retro-reflective sheeting, alphanumeric plates, and pavement markings. The particles and fibers are useful, for example, as thermal insulation, filler, or reinforcing material in composites (e.g., ceramic, metal, or polymeric matrix composites). The thin coatings can be useful, for example, as protective coatings in applications involving wear, as well as for thermal management. Examples of articles made according to a method of the present invention include kitchenware (e.g., plates), dental appliances and prostheses (e.g., orthodontic brackets, crowns, bridges, onlays and inlays), and reinforcing fibers, cutting tool inserts, abrasive materials, and structural components of gas engines, (e.g., valves and bearings). Embodiments of ceramics made according to the present invention may be useful as a high dielectric constant material, and may be useful, for example, in electronic packaging and other applications involving electronic circuitry. Embodiments of ceramics made according to the present invention may be useful as substrate materials for read-write magnetic heads. Embodiments of ceramics made according to the present invention (e.g., those having very fine microstructures) may be useful as a low friction materials in applications involving frictional sliding. Embodiments of ceramics made according to the present invention may be useful as protective coatings. Certain ceramic particles made according to a method of the present invention can be particularly useful as abrasive particles. The abrasive particles can be incorporated into an abrasive article, or used in loose form.

The ceramic abrasive particles can be made, for example, by crushing resulting ceramic to provide ceramic abrasive particles. In some embodiments, the method further comprises grading the ceramic abrasive particles to provide a plurality of abrasive particles having a specified nominal grade. The ceramic abrasive particles can also be made, for example, by having the precursor material in the form of particles. In some embodiments, such precursor material particles are provided as a plurality of particles having a specified nominal grade, wherein at least a portion of the plurality of particles are the precursor abrasive particles, and, optionally, in addition, the method further comprises grading the ceramic abrasive particles to provide a plurality of abrasive particles having a specified nominal grade.

Ceramic abrasive particles made according to a method of the present invention are useful, for example, in loose form or used incorporated into abrasive articles. Abrasive articles according to the present invention comprise binder and a plurality of abrasive particles, wherein at least a portion of the abrasive particles are ceramic abrasive particles made according to a method of the present invention. Exemplary abrasive products include coated abrasive articles, bonded abrasive articles (e.g., wheels), non-woven abrasive articles, and abrasive brushes. Coated abrasive articles typically comprise a backing having first and second, opposed major surfaces, and wherein the binder and the plurality of abrasive particles form an abrasive layer on at least a portion of the first major surface.

Abrasive particles are usually graded to a given particle size distribution before use. Such distributions typically have a range of particle sizes, from coarse particles to fine particles. In the abrasive art this range is sometimes referred to as a “coarse”, “control” and “fine” fractions. Abrasive particles graded according to industry accepted grading standards specify the particle size distribution for each nominal grade within numerical limits. Such industry accepted grading standards (i.e., specified nominal grades) include those known as the American National Standards Institute, Inc. (ANSI) standards, Federation of European Producers of Abrasive Products (FEPA) standards, and Japanese Industrial Standard (JIS) standards. In one aspect, the present invention provides a plurality of abrasive particles having a specified nominal grade, wherein at least a portion of the plurality of abrasive particles are ceramic abrasive particles made according to a method of the present invention. In some embodiments, at least 5, 10, 15, 20, 25, 30, 35, 40, 45, 50 55, 60, 65, 70, 75, 80, 85, 90, 95, or even 100 percent by weight of the plurality of abrasive particles are ceramic abrasive particles made according to a method of the present invention, based on the total weight of the plurality of abrasive particles.

In this application:

“alpha Al₂O₃ nucleating agent” refers to alpha alumina seeds or a material isostructural with alpha Al₂O₃ that enhances the transformation of transitional alumina(s) to alpha alumina via extrinsic nucleation (known alpha Al₂O₃ nucleating agents include alpha Fe₂O₃, alpha Cr₂O₃, Ti₂O₃, and titanates (such as Mg Ti₂O₄ and NiTi₂O₄));

“alpha Al₂O₃ nucleating agent equivalent” refers to a precursor material that converts to an alpha Al₂O₃ nucleating agent when heated up to 900° C. in air at 1 atmosphere (known equivalent includes diaspore (i.e., AlOOH) and FeOOH;

“amorphous material” refers to material derived from a melt and/or vapor phase that lacks any long range crystal structure as determined by X-ray diffraction and/or has an exothermic peak corresponding to the crystallization of the amorphous material as determined by a DTA (differential thermal analysis) as determined by the test described herein entitled “Differential Thermal Analysis”;

“ceramic” includes amorphous material, glass, crystalline ceramic, glass-ceramic, and combinations thereof;

“complex metal oxide” refers to a metal oxide comprising two or more different metal elements and oxygen (e.g., CeA₁₁O₁₈, Dy₃Al₅O₁₂, MgAl₂O₄, and Y₃Al₅O₁₂);

“complex Al₂O₃.metal oxide” refers to a complex metal oxide comprising, on a theoretical oxide basis, Al₂O₃ and one or more metal elements other than Al (e.g., CeAl₁₁O₁₈, Dy₃Al₅O₁₂, MgAl₂O₄, and Y₃Al₅O₁₂);

“complex Al₂O₃.Y₂O₃” refers to a complex metal oxide comprising, on a theoretical oxide basis, Al₂O₃ and Y₂O₃ (e.g., Y₃Al₅O₁₂);

“complex Al₂O₃.REO” refers to a complex metal oxide comprising, on a theoretical oxide basis, Al₂O₃ and rare earth oxide (e.g., CeAl₁₁O₁₈ and Dy₃Al₅O₁₂);

“glass” refers to amorphous material exhibiting a glass transition temperature;

“glass-ceramic” refers to ceramics comprising crystals formed by heat-treating glass;

“T_{g}” refers to the glass transition temperature as determined by the test described herein entitled “Differential Thermal Analysis”;

“Tₓ” refers to the crystallization temperature as determined by the test described herein entitled “Differential Thermal Analysis”;

“rare earth oxides” refers to cerium oxide (e.g.,CeO₂), dysprosium oxide (e.g., Dy₂O₃), erbium oxide (e.g., Er₂O₃), europium oxide (e.g., Eu₂O₃), gadolinium (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium (e.g., Tb₂O₃), thorium oxide (e.g., Th₄O₇), thulium (e.g., Tm₂O₃), and ytterbium oxide (e.g., Yb₂O₃), and combinations thereof; and

“REO” refers to rare earth oxide(s).

Further, it is understood herein that unless it is stated that a metal oxide (e.g., Al₂O₃, complex Al₂O₃-metal oxide, etc.) is crystalline, for example, in a glass-ceramic, it may be amorphous, crystalline, or portions amorphous and portions crystalline. For example if a glass-ceramic comprises Al₂O₃ and ZrO₂, the Al₂O₃ and ZrO₂ may each be in an amorphous state, crystalline state, or portions in an amorphous state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides.

Further, it is understood that glass-ceramics formed by heating amorphous material not exhibit a T_{g} may not actually comprise glass, but rather may comprise the crystals and amorphous material that does not exhibit a T_{g}.

Embodiments of the present invention include crystallizing amorphous material (e.g., glass) or amorphous material in a ceramic comprising the amorphous material to provide a glass-ceramic. In some embodiments, such amorphous materials contain not more than 30 (in some embodiments, not more than 25, 20, 15, 10, 5, 4, 3, 2, 1, or even zero) percent by weight collectively As₂O₃, B₂O₃, GeO₂, P₂O₅, SiO₂, TeO₂, and V₂O₅, based on the total weight of the amorphous material.

In some embodiments, such amorphous materials comprise at least 35, 40, 45, 50, 55, 60, 65, 70, 75, 80, 85, or even at least 90% by weight Al₂O₃, based on the total weight of the amorphous materials. In some embodiments, such amorphous materials comprise 30 to at least 90 percent by weight (in some embodiments, 35 to at least 90 percent, 40 to at least 90 percent, 50 to at least 90 percent, or even 60 to at least 90 percent) Al₂O₃; 0 to 50 percent by weight (in some embodiments, 0 to 25 percent; or even 0 to 10 percent) Y₂O₃; and 0 to 50 percent by weight (in some embodiments, 0 to 25 percent; or even 0 to 10 percent) at least one of ZrO₂ or HfO₂, based on the total weight of the amorphous material. In some embodiments, such amorphous materials comprise at least 30, 40, 50, 60, 70, 75, 80, 85, or even at least 90 percent by weight Al₂O₃, based on the total weight of the amorphous material. In some embodiments, such amorphous materials contain not more than 40 (in some embodiments, not more than 35, 30, 25, 20, 15, 10, 5, 4, 3, 2, 1, or even zero) percent by weight collectively SiO₂, B₂O₃, and P₂O₅, based on the total weight of the amorphous material. In some embodiments, such amorphous materials contain not more than 20 (in some embodiments, not more than 15, 10, 5, or even zero) percent by weight SiO₂ and not more than 20 (in some embodiments, not more than 15, 10, 5, or even zero) zero) percent by weight B₂O₃, based on the total weight of the amorphous material.

In some embodiments, such amorphous materials comprise 30 to at least 90 (in some embodiments, 35, 40, 45, 50, 55, 60, 65, 70, 75, 80, 85, or even at least 90) percent by weight Al₂O₃; 0 to 50 percent by weight (in some embodiments, 0 to 25 percent; or even 0 to 10 percent) REO; 0 to 50 percent by weight (in some embodiments, 0 to 25 percent; or even 0 to 10 percent) at least one of ZrO₂ or HfO₂, based on the total weight of the amorphous material. In some embodiments, such amorphous materials comprise at least 30 percent by weight, at least 40 percent by weight, at least 50 percent by weight, at least 60 percent by weight, or even at least 70 percent by weight Al₂O₃, based on the total weight of the amorphous material. In some embodiments, such amorphous materials comprise not more than 40 (in some embodiments, not more than 35, 30, 25, 20, 15, 10, 5, 4, 3, 2, 1, or even zero) zero) percent by weight collectively SiO₂, B₂O₃, and P₂O₅, based on the total weight of the amorphous materials. In some embodiments, such amorphous materials contain not more than 20 (in some embodiments, not more than 15, 10, 5, or even zero) percent by weight SiO₂ and not more than 20 (in some embodiments, not more than 15, 10, 5, or even zero) percent by weight B₂O₃, based on the total weight of the amorphous material.

In some embodiments, such amorphous materials comprise 30 to at least 90 (in some embodiments, 35 to at least 90 percent, 40 to at least 90 percent, 50 to at least 90 percent, or even 60 to 90 percent) percent by weight Al₂O₃; 0 to 50 percent by weight (in some embodiments, 0 to 25 percent; or even 0 to 10 percent) Y₂O₃; 0 to 50 percent by weight (in some embodiments, 0 to 25 percent; or even 0 to 10 percent) REO, 0 to 50 percent by weight (in some embodiments, 0 to 25 percent; or even 0 to 10 percent) at least one of ZrO₂ or HfO₂, based on the total weight of the amorphous material. In some embodiments, such amorphous materials comprise at least 35 (in some embodiments, 40, 50, 60, 70, 75, 80, 85, or even at least 90) percent by weight Al₂O₃, based on the total weight of the amorphous material. In some embodiments, such amorphous materials contain not more than 40 (in some embodiments, not more than 35, 30, 25, 20, 15, 10, 5, 4, 3, 2, 1, or even zero) percent by weight collectively SiO₂, B₂O₃, and P₂O₅, based on the total weight of the amorphous material or glass-ceramic. In some embodiments, such amorphous materials contain not more than 20 (in some embodiments, not more than 15, 10, 5, or even zero) percent by weight SiO₂ and not more than 20 (in some embodiments, not more than 15, 10, 5, or even zero) percent by weight B₂O₃, based on the total weight of the amorphous material.

In another aspect, the present invention provides a method of abrading a surface, the method comprising providing an abrasive article comprising a binder and a plurality of abrasive particles, wherein at least a portion of the abrasive particles are ceramic abrasive particles made according to a method of the present invention; contacting at least one of the ceramic abrasive particles made according to a method of the present invention with a surface of a workpiece; and moving at least one of the contacted ceramic abrasive particles made according to a method of the present invention or the contacted surface to abrade at least a portion of the surface with the contacted ceramic abrasive particle made according to the of the present invention.

As compared to many other types of ceramic processing (e.g., sintering of a calcined material to a dense, sintered ceramic material), there is relatively little shrinkage (typically, less than 30 percent by volume; in some embodiments, less than 20 percent, 10 percent, 5 percent, or even less than 3 percent by volume) during conversion of the precursor material to the final ceramic. The actual amount of shrinkage depends, for example, on the composition of the precursor material, the heating time, the heating temperature, the heating pressure, the density of the precursor material, the relative amount(s) of the crystalline phases formed, and the degree of crystallization. The amount of shrinkage can be measured by conventional techniques known in the art, including by dilatometry, Archimedes method, or measuring the dimensions of the material before and after heating. In some cases, there may be some evolution of volatile species during heat-treatment.

In some embodiments, the relatively low shrinkage feature may be particularly advantageous. For example, articles may be formed in the glass phase to the desired shapes and dimensions (i.e., in near-net shape), followed by heating to provide the final ceramic. As a result, substantial cost savings associated with the manufacturing and machining of the crystallized material may be realized.

In some embodiments, the ceramic has an x, y, z direction, each of which has a length of at least 100 micrometers (in some embodiments, at least 150 micrometers, 200 micrometers, 250 micrometers, 500 micrometers, 1 mm, 5 mm, 10 mm, 1 cm, 5 cm, or even at least 10 cm).

In some embodiments, the precursor material has an x, y, z direction, each of which has a length of at least 1 cm (in some embodiments, at least 5 cm, or even at least 10 cm), wherein the precursor material has a volume, wherein the resulting ceramic has an x, y, z direction, each of which has a length of at least 1 cm (in some embodiments, at least 5 cm, or even at least 10 cm), wherein the ceramic has a volume of at least 70 (in some embodiments, at least 75, 80, 85, 90, 95, 96, or even at least 97) percent of the precursor material volume.

### BRIEF DESCRIPTION OF THE DRAWING

FIG. 1 is a fragmentary cross-sectional schematic view of a coated abrasive article including ceramic abrasive particles made according to a method of the present invention.

FIG. 2 is a perspective view of a bonded abrasive article including ceramic abrasive particles made according to a method of the present invention.

FIG. 3 is an enlarged schematic view of a nonwoven abrasive article including ceramic abrasive particles made according to a method of the present invention.

FIG. 4 is a DTA of material prepared in Example 1.

FIG. 5 is a back-scattered electron digital micrograph of a polished section of a material from Example 3.

FIG. 6 is a Dilatometer trace of a material from Example 1.

### DETAILED DESCRIPTION

The present invention provides a method for making ceramics comprising alumina (in some embodiments, alpha alumina).

Sources, including commercial sources, of (on a theoretical oxide basis) Al₂O₃ include bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. The Al₂O₃ source may contain, or only provide, Al₂O₃. Alternatively, the Al₂O₃ source may contain, or provide Al₂O₃, as well as one or more metal oxides other than Al₂O₃ (including materials of or containing complex Al₂O₃.metal oxides (e.g., Dy₃Al₅O₁₂, Y₃Al₅O₁₂, CeAl₁₁O₁₈, etc.)).

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxide-other metal oxides (e.g., Dy₃Al₅O₁₂, CeAl₁₁O₁₈, etc.)).

Sources, including commercial sources, of (on a theoretical oxide basis) Y₂O₃ include yttrium oxide powders, yttrium, yttrium-containing ores, and yttrium salts (e.g., yttrium carbonates, nitrates, chlorides, hydroxides, and combinations thereof). The Y₂O₃ source may contain, or only provide, Y₂O₃. Alternatively, the Y₂O₃ source may contain, or provide Y₂O₃, as well as one or more metal oxides other than Y₂O₃ (including materials of or containing complex Y₂O₃.metal oxides (e.g., Y₃Al5O₁₂)).

Other useful metal oxide may also include, on a theoretical oxide basis, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof. Sources, including commercial sources, include the oxides themselves, metal powders, complex oxides, ores, carbonates, acetates, nitrates, chlorides, hydroxides, etc. These metal oxides are added to modify a physical property of the resulting abrasive particles and/or improve processing. These metal oxides are typically are added anywhere from 0 to 50% by weight, in some embodiments 0 to 25% by weight, or even 0 to 50% by weight of the ceramic depending, for example, upon the desired property.

For embodiments comprising ZrO₂ and HfO₂, the weight ratio of ZrO₂:HfO₂ may be in a range of 1:zero (i.e., all ZrO₂; no HfO₂) to zero: 1, as well as, for example, at least about 99, 98, 97, 96, 95, 90, 85, 80, 75, 70, 65, 60, 55, 50, 45, 40, 35, 30, 25, 20, 20, 15, 10, and 5 parts (by weight) ZrO₂ and a corresponding amount of HfO₂ (e.g., at least about 99,parts (by weight) ZrO₂ and not greater than about 1 part HfO₂) and at least about 99, 98, 97, 96, 95, 90, 85, 80, 75, 70, 65, 60, 55, 50, 45, 40, 35, 30, 25, 20, 20, 15, 10, and 5 parts HfO₂ and a corresponding amount of ZrO₂.

Sources, including commercial sources, of (on a theoretical oxide basis) ZrO₂ include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the ZrO₂ source may contain, or provide ZrO₂, as well as other metal oxides such as hafnia. Sources, including commercial sources, of (on a theoretical oxide basis) HfO₂ include hafnium oxide powders, hafnium, hafnium-containing ores, and hafnium salts. In addition, or alternatively, the HfO₂ source may contain, or provide HfO₂, as well as other metal oxides such as ZrO₂.

In some embodiments, it may be advantageous for at least a portion of a metal oxide source (in some embodiments, 10, 15, 20, 25, 30, 35, 40, 45, 50, 55, 60, 65, 70, 75, 80, 85, 90, 95, or even 100 percent by weight) to be obtained by adding particulate, metallic material comprising at least one of a metal (e.g., Al, Ca, Cu, Cr, Fe, Li, Mg, Ni, Ag, Ti, Zr, and combinations thereof), M, that has a negative enthalpy of oxide formation or an alloy thereof to the melt, or otherwise combining them with the other raw materials. Although not wanting to be bound by theory, it is believed that the heat resulting from the exothermic reaction associated with the oxidation of the metal is beneficial in the formation of a homogeneous melt and resulting amorphous material. For example, it is believed that the additional heat generated by the oxidation reaction within the raw material eliminates or minimizes insufficient heat transfer, and hence facilitates formation and homogeneity of the melt, particularly when forming amorphous particles with x, y, and z dimensions over 50 (over 100, or even over 150) micrometers. It is also believed that the availability of the additional heat aids in driving various chemical reactions and physical processes (e.g., densification, and spherodization) to completion. Further, it is believed for some embodiments, the presence of the additional heat generated by the oxidation reaction actually enables the formation of a melt, which otherwise is difficult or otherwise not practical due to high melting point of the materials. Further, the presence of the additional heat generated by the oxidation reaction actually enables the formation of amorphous material that otherwise could not be made, or could not be made in the desired size range. Another advantage of the invention include, in forming the amorphous materials, that many of the chemical and physical processes such as melting, densification and spherodizing can be achieved in a short time, so that very high quench rates may be achieved. For additional details, see co-pending application having U.S. Ser. No. ______ (Attorney Docket No. 56931US007), filed Aug. 2, 2002, the disclosure of which is incorporated herein by reference.

Techniques for processing the raw materials include melting them. In one aspect of the invention, the raw materials are fed independently to form the molten mixture. In another aspect of the invention, certain raw materials are mixed together, while other raw materials are added independently into the molten mixture. In some embodiments, for example, the raw materials are combined or mixed together prior to melting. The raw materials may be combined in any suitable and known manner to form a substantially homogeneous mixture. These combining techniques include ball milling, mixing, tumbling and the like. The milling media in the ball mill may be metal balls, ceramic balls and the like. The ceramic milling media may be, for example, alumina, zirconia, silica, magnesia and the like. The ball milling may occur dry, in an aqueous environment, or in a solvent-based (e.g., isopropyl alcohol) environment. If the raw material batch contains metal powders, then it is generally desired to use a solvent during milling. This solvent may be any suitable material with the appropriate flash point and ability to disperse the raw materials. The milling time may be from a few minutes to a few days, generally between a few hours to 24 hours. In a wet or solvent based milling system, the liquid medium is removed, typically by drying, so that the resulting mixture is typically homogeneous and substantially devoid of the water and/or solvent. If a solvent based milling system is used, during drying, a solvent recovery system may be employed to recycle the solvent. After drying, the resulting mixture may be in the form of a “dried cake”. This cake like mixture may then be broken up or crushed into the desired particle size prior to melting. Alternatively, for example, spray-drying techniques may be used. The latter typically provides spherical particulates of a desired oxide mixture. The precursor material may also be prepared by wet chemical methods including precipitation and sol-gel. Such methods will be beneficial if extremely high levels of homogeneity are desired.

Particulate raw materials are typically selected to have particle sizes such that the formation of a homogeneous melt can be achieved rapidly. Typically, raw materials with relatively small average particle sizes and narrow distributions are used for this purpose. In some methods (e.g., flame forming and plasma spraying), particularly desirable particulate raw materials are those having an average particle size in a range from about 5 nm to about 50 micrometers (in some embodiments, in a range from about 10 nm to about 20 micrometers, or even about 15 nm to about 1 micrometer), wherein at least 90 (in some embodiments, 95, or even 100) percent by weight of the particulate, although sizes outside of the sizes and ranges may also be useful. Particulate less than about 5 nm in size tends to be difficult to handle (e.g., the flow properties of the feed particles tended to be undesirable as they tend to have poor flow properties). Use of particulate larger than about 50 micrometers in typical flame forming or plasma spraying processes tend to make it more difficult to obtain homogenous melts and amorphous materials and/or the desired composition.

Furthermore, in some cases, for example, when particulate material is fed in to a flame or thermal or plasma spray apparatus, to form the melt, it may be desirable for the particulate raw materials to be provided in a range of particle sizes. Although not wanting to be bound by theory, it is believed that this maximizes the packing density and strength of the feed particles. In general the coarsest raw material particles are smaller than the desired melt or glass particle sizes. Further, raw material particles that are too coarse, tend to have insufficient thermal and mechanical stresses in the feed particles, for example, during a flame forming or plasma spraying step. The end result in such cases is generally, fracturing of the feed particles in to smaller fragments, loss of compositional uniformity, loss of yield in desired glass particle sizes, or even incomplete melting as the fragments generally change their trajectories in a multitude of directions out of the heat source.

The amorphous materials (including glasses) and ceramics comprising amorphous materials can be made, for example, by heating (including in a flame or plasma) the appropriate metal oxide sources to form a melt, desirably a homogenous melt, and then rapidly cooling the melt to provide amorphous material. Some embodiments of amorphous materials can be made, for example, by melting the metal oxide sources in any suitable furnace (e.g., an inductively or resistively heated furnace, a gas-fired furnace, or an electric arc furnace).

The amorphous materials (a precursor material) is typically obtained by relatively rapidly cooling the molten material (i.e., the melt). The quench rate (i.e., the cooling time) to obtain the amorphous material depends upon many factors, including the chemical composition of the melt, the amorphous-forming ability of the components, the thermal properties of the melt and the resulting amorphous material, the processing technique(s), the dimensions and mass of the resulting amorphous material, and the cooling technique. In general, relatively higher quench rates are required to form amorphous materials comprising higher amounts of Al₂O₃ (i.e., greater than 75 percent by weight Al₂O₃), especially in the absence of known glass formers such as SiO₂, B₂O₃, P₂O₅, GeO₂, TeO₂, As₂O₃, and V₂O₅. Similarly, it is more difficult to cool melts into amorphous materials in larger dimensions, as it is more difficult to remove heat fast enough.

In some embodiments of the invention, the raw materials are heated into a molten state in a particulate form and subsequently cooled into amorphous particles. Typically, the particles have a particle size greater than 25 micrometers (in some embodiments, greater than 50, 100, 150 or even 200 micrometers).

The quench rates achieved in making the amorphous materials are believed to be higher than 10³, 10⁴, 10⁵ or even 10⁶° C./sec (i.e., a temperature drop of 1000° C. from a molten state in less than a second, less than a tenth of a second, less than a hundredth of a second or even less than a thousandth of a second, respectively). Techniques for cooling the melt include discharging the melt into a cooling media (e.g., high velocity air jets, liquids (e.g., cold water), metal plates (including chilled metal plates), metal rolls (including chilled metal rolls), metal balls (including chilled metal balls), and the like)). Other cooling techniques known in the art include roll-chilling. Roll-chilling can be carried out, for example, by melting the metal oxide sources at a temperature typically 20-200° C. higher than the melting point, and cooling/quenching the melt by spraying it under high pressure (e.g., using a gas such as air, argon, nitrogen or the like) onto a high-speed rotary roll(s). Typically, the rolls are made of metal and are water-cooled. Metal book molds may also be useful for cooling/quenching the melt.

The cooling rate is believed to affect the properties of the quenched amorphous material. For instance, glass transition temperature, density and other properties of an amorphous material typically change with cooling rates.

Rapid cooling may also be conducted under controlled atmospheres, such as a reducing, neutral, or oxidizing environment to maintain and/or influence the desired oxidation states, etc. during cooling. The atmosphere can also influence amorphous material formation by influencing crystallization kinetics from undercooled liquid. For example, larger undercooling of Al₂O₃ melts without crystallization has been reported in argon atmosphere as compared to that in air.

Embodiments of amorphous material can be made utilizing flame fusion as disclosed, for example, in U.S. Pat. No. 6,254,981 (Castle), the disclosure of which is incorporated herein by reference. In this method, the metal oxide sources materials are fed (e.g., in the form of particles, sometimes referred to as “feed particles”) directly into a burner (e.g., a methane-air burner, an acetylene-oxygen burner, a hydrogen-oxygen burner, and like), and then quenched, for example, in water, cooling oil, air, or the like. Feed particles can be formed, for example, by grinding, agglomerating (e.g., spray-drying), melting, or sintering the metal oxide sources.

Embodiments of amorphous materials can also be obtained by other techniques, such as: laser spin melt with free fall cooling, Taylor wire technique, plasmatron technique, hammer and anvil technique, centrifugal quenching, air gun splat cooling, single roller and twin roller quenching, roller-plate quenching and pendant drop melt extraction (see, e.g., Rapid Solidification of Ceramics, Brockway et. al, Metals And Ceramics Information Center, A Department of Defense Information Analysis Center, Columbus, Ohio, January, 1984, the disclosure of which is incorporated here as a reference). Embodiments of amorphous materials may also be obtained by other techniques, such as: thermal (including flame or laser or plasma-assisted) pyrolysis of suitable precursors, physical vapor synthesis (PVS) of metal precursors and mechanochemical processing.

Other techniques for forming melts, cooling/quenching melts, and/or otherwise forming amorphous material include vapor phase quenching, melt-extraction, plasma spraying, and gas or centrifugal atomization. Vapor phase quenching can be carried out, for example, by sputtering, wherein the metal alloys or metal oxide sources are formed into a sputtering target(s). The target is fixed at a predetermined position in a sputtering apparatus, and a substrate(s) to be coated is placed at a position opposing the target(s). Typical pressures of 10⁻³ torr of oxygen gas and Ar gas, discharge is generated between the target(s) and a substrate(s), and Ar or oxygen ions collide against the target to start reaction sputtering, thereby depositing a film of composition on the substrate. For additional details regarding plasma spraying, see, for example, co-pending application having U.S. Ser. No. 10/211,640, filed Aug. 2, 2002, the disclosure of which is incorporated herein by reference.

Gas atomization involves melting feed particles to convert them to melt. A thin stream of such melt is atomized through contact with a disruptive air jet (i.e., the stream is divided into fine droplets). The resulting substantially discrete, generally ellipsoidal amorphous material comprising particles (e.g., beads) are then recovered. Examples of bead sizes include those having a diameter in a range of about 5 micrometers to about 3 mm. Melt-extraction can be carried out, for example, as disclosed in U.S. Pat. No. 5,605,870 (Strom-Olsen et al.), the disclosure of which is incorporated herein by reference. Container-less glass forming techniques utilizing laser beam heating as disclosed, for example, in U.S. Pat. No. 6,482,758 (Weber), the disclosure of which is incorporated herein by reference, may also be useful in making materials according to the present invention.

Typically, it is desirable that the bulk material comprises at least 50, 60, 75, 80, 85, 90, 95, 98, 99, or even 100 percent by weight of the amorphous material.

Typically, amorphous materials have x, y, and z dimensions each perpendicular to each other, and wherein each of the x, y, and z dimensions is at least 25 micrometers. In some embodiments, the x, y, and z dimensions is at least 50 micrometers, 75 micrometers, 100 micrometers, 250 micrometers, 500 micrometers, 1000 micrometers, 2000 micrometers, 2500 micrometers, 1 mm, or even at least 5 mm, if coalesced. The x, y, and z dimensions of a material are determined either visually or using microscopy, depending on the magnitude of the dimensions. The reported z dimension is, for example, the diameter of a sphere, the thickness of a coating, or the shortest dimension of a prismatic shape.

The addition of certain metal oxides may alter the properties and/or crystalline structure or microstructure of the ceramic, as well as the processing of the raw materials and intermediates in making the ceramic. For example, oxide additions such as MgO, CaO, Li₂O, MgO, and Na₂O have been observed to alter both the T_{g} (for a glass) and Tₓ (wherein Tₓ is the crystallization temperature) of amorphous material. Although not wishing to be bound by theory, it is believed that such additions influence amorphous material formation. Further, for example, such oxide additions may decrease the melting temperature of the overall system (i.e., drive the system toward lower melting eutectic), and ease of amorphous material-formation. Complex eutectics in multi component systems (quaternary, etc.) may result in better amorphous materials-forming ability. The viscosity of the liquid melt and viscosity of the glass in its' working range may also be affected by the addition of certain metal oxides such as MgO, CaO, Li₂O, and Na₂O. It is also within the scope of the present invention to incorporate at least one of halogens (e.g., fluorine and chlorine), or chalcogenides (e.g., sulfides, selenides, and tellurides) into the amorphous materials, and the ceramics made there from.

Crystallization of the amorphous material may also be affected by the additions of certain materials. For example, certain metals, metal oxides (e.g., titanates and zirconates), and fluorides may act as nucleation agents resulting in beneficial heterogeneous nucleation of crystals. Also, addition of some oxides may change the nature of metastable phases devitrifying from the amorphous material upon reheating. In another aspect, for ceramics comprising crystalline ZrO₂, it may be desirable to add metal oxides (e.g., Y₂O₃, TiO₂, CaO, and MgO) that are known to stabilize tetragonal/cubic form of ZrO₂.

The particular selection of metal oxide sources and other additives for practicing a method according to the present invention typically takes into account, for example, the desired composition, the microstructure, the degree of crystallinity, the physical properties (e.g., hardness or toughness), the presence of undesirable impurities, and the desired or required characteristics of the particular process (including equipment and any purification of the raw materials before and/or during fusion and/or solidification) being used to prepare the ceramics.

In some instances, it may be desirable to incorporate limited amounts of metal oxides selected from the group consisting of: Na₂O, P₂O₅, SiO₂, TeO₂, V₂O₃, and combinations thereof. Sources, including commercial sources, include the oxides themselves, complex oxides, elemental (e.g., Si) powders, ores, carbonates, acetates, nitrates, chlorides, hydroxides, etc. These metal oxides may be added, for example, to modify a physical property of the resulting ceramic and/or improve processing. These metal oxides when used are typically are added from greater than 0 to 20% by weight collectively (in some embodiments, greater than 0 to 5% by weight collectively, or even greater than 0 to 2% by weight collectively) of the ceramic depending, for example, upon the desired property.

Useful amorphous material formulations include those at or near a eutectic composition(s) (e.g., binary and ternary eutectic compositions). In addition to compositions disclosed herein, other compositions, including quaternary and other higher order eutectic compositions, may be apparent to those skilled in the art after reviewing the present disclosure.

The microstructure or phase composition (glassy/amorphous/crystalline) of a material can be determined in a number of ways. Various information can be obtained using optical microscopy, electron microscopy, differential thermal analysis (DTA), and x-ray diffraction (XRD), for example.

Using optical microscopy, amorphous material is typically predominantly transparent due to the lack of light scattering centers such as crystal boundaries, while crystalline material shows a crystalline structure and is opaque due to light scattering effects.

A percent amorphous yield can be calculated for particles (e.g., beads), etc. using a −100+120 mesh size fraction (i.e., the fraction collected between 150-micrometer opening size and 125-micrometer opening size screens). The measurements are done in the following manner. A single layer of particles, beads, etc. is spread out upon a glass slide. The particles, beads, etc. are observed using an optical microscope. Using the crosshairs in the optical microscope eyepiece as a guide, particles, beads, etc. that lay along a straight line are counted either amorphous or crystalline depending on their optical clarity. A total of 500 particles, beads, etc. are typically counted, although fewer particles, beads, etc. may be used and a percent amorphous yield is determined by the amount of amorphous particles, beads, etc. divided by total particles, beads, etc. counted. Embodiments of methods according to the have percent glass yields of at least 50, 60, 70, 75, 80, 85, 90, 95, or even 100 percent.

If it is desired for all the particles to be amorphous (or glass), and the resulting yield is less than 100%, the amorphous (or glass) particles may be separated from the non-amorphous (or non-glass) particles. Such separation may be done, for example, by any conventional techniques, including separating based upon density or optical clarity.

Using DTA, the material is classified as amorphous if the corresponding DTA trace of the material contains an exothermic crystallization event (Tₓ). If the same trace also contains an endothermic event (T_{g}) at a temperature lower than Tₓ it is considered to consist of a glass phase. If the DTA trace of the material contains no such events, it is considered to contain crystalline phases.

Differential thermal analysis (DTA) can be conducted using the following method. DTA runs can be made (using an instrument such as that obtained from Netzsch Instruments, Selb, Germany under the trade designation “NETZSCH STA 409 DTA/TGA”) using a −140+170 mesh size fraction (i.e., the fraction collected between 105-micrometer opening size and 90-micrometer opening size screens). An amount of each screened sample (typically about 400 milligrams (mg)) is placed in a 100-microliter Al₂O₃ sample holder. Each sample is heated in static air at a rate of 10° C./minute from room temperature (about 25° C.) to 1100° C.

Using powder x-ray diffraction, XRD, (using an x-ray diffractometer such as that obtained under the trade designation “PHILLIPS XRG 3100” from Phillips, Mahwah, N.J., with copper K α1 radiation of 1.54050 Angstrom) the phases present in a material can be determined by comparing the peaks present in the XRD trace of the crystallized material to XRD patterns of crystalline phases provided in JCPDS (Joint Committee on Powder Diffraction Standards) databases, published by International Center for Diffraction Data. Furthermore, XRD can be used qualitatively to determine types of phases. The presence of a broad diffused intensity peak is taken as an indication of the amorphous nature of a material. The existence of both a broad peak and well-defined peaks is taken as an indication of existence of crystalline matter within an amorphous matrix.

The initially formed amorphous material may be larger in size than that desired. If the glass is in a desired geometric shape and/or size, size reduction is typically not needed. The amorphous material or ceramic can be, and typically is, converted into smaller pieces using crushing and/or comminuting techniques known in the art, including roll crushing, jaw crushing, hammer milling, ball milling, jet milling, impact crushing, and the like. In some instances, it is desired to have two or multiple crushing steps. For example, after the ceramic is formed (solidified), it may be in the form of larger than desired. The first crushing step may involve crushing these relatively large masses or “chunks” to form smaller pieces. This crushing of these chunks may be accomplished with a hammer mill, impact crusher or jaw crusher. These smaller pieces may then be subsequently crushed to produce the desired particle size distribution. In order to produce the desired particle size distribution (sometimes referred to as grit size or grade), it may be necessary to perform multiple crushing steps. In general the crushing conditions are optimized to achieve the desired particle shape(s) and particle size distribution. Resulting particles that are not of the desired size may be re-crushed if they are too large, or “recycled” and used as a raw material for re-melting if they are too small.

The shape of ceramic abrasive particles made according to the present invention can depend, for example, on the composition and/or microstructure of the ceramic, the geometry in which it was cooled, and the manner in which the ceramic is crushed (i.e., the crushing technique used). In general, where a “blocky” shape is preferred, more energy may be employed to achieve this shape. Conversely, where a “sharp” shape is preferred, less energy may be employed to achieve this shape. The crushing technique may also be changed to achieve different desired shapes. For abrasive particles an average aspect ratio ranging from 1:1 to 5:1 is typically desired, and in some embodiments 1.25:1 to 3:1, or even 1.5:1 to 2.5:1.

It is also within the scope of the present invention, for example, to directly form precursor abrasive particles in desired shapes. For example, precursor abrasive particles may be formed (including molded) by pouring or forming the melt into a mold. Also see, for example, the forming techniques described in application having U.S. Ser. No. ______ (Attorney Docket No. 58257US002), filed the same date as the instant application, the disclosure of which is incorporated herein by reference.

It is also within the scope of the present invention, for example, to fabricate the ceramic precursor into a desired shape by coalescing. This coalescing step in essence forms a larger sized body from two or more smaller particles. For example, amorphous material comprising particles (obtained, for example, by crushing) (including beads and microspheres), fibers, etc. may be heated above the T_{g} such that the particles, etc. coalesce to form a shape and cooling the coalesced shape. The temperature and pressure used for coalescing may depend, for example, upon composition of the amorphous material and the desired density of the resulting material. The temperature should be below glass crystallization temperature, and for glasses, greater than the glass transition temperature. In certain embodiments, the heating is conducted at at least one temperature in a range of about 850° C. to about 1100° C. (in some embodiments, 900° C. to 1000° C.). Typically, the amorphous material is under pressure (e.g., greater than zero to 1 GPa or more) during coalescence to aid the coalescence of the amorphous material. In one embodiment, a charge of the particles, etc. is placed into a die and hot-pressing is performed at temperatures above glass transition where viscous flow of glass leads to coalescence into a relatively large part. Examples of typical coalescing techniques include hot pressing, hot isostatic pressing, hot extrusion, hot forging and the like (e.g., sintering, plasma assisted sintering). Typically, it is generally desirable to cool the resulting coalesced body before further heat-treatment. After heat-treatment, if so desired, the coalesced body may be crushed to smaller particle sizes or a desired particle size distribution.

The alpha alumina precursor can be heated to provide alpha alumina (e.g., amorphous material is heat-treated to at least partially crystallize the amorphous material to provide glass-ceramic comprising alumina (in some embodiments, alpha alumina). In general, heat-treatment can be carried out in any of a variety of ways, including those known in the art for heat-treating glass to provide glass-ceramics. For example, heat-treatment can be conducted in batches, for example, using resistive, inductively or gas heated furnaces. Alternatively, for example, heat-treatment (or a portion thereof) can be conducted continuously, for example, using a rotary kiln or pendulum kiln. In the case of a rotary kiln, fluidized bed furnaces, or a pendulum kiln, the material is typically fed directly into the kiln operating at the elevated temperature. In the case of a fluidized bed furnace, the glass to be heat-treated is typically suspended in a gas (e.g., air, inert, or reducing gasses). The time at the elevated temperature may range from a few seconds (in some embodiments even less than 5 seconds) to a few minutes to several hours. The temperature typically ranges from the Tₓ of the amorphous material to 1250° C., more typically from 900° C. to 1250° C., and in some embodiments, from 1050° C. to 1250° C. It is also within the scope of the present invention to perform some of the heat-treatment in multiple steps (e.g., one for nucleation, and another for crystal growth; wherein densification also typically occurs during the crystal growth step). When a multiple step heat-treatment is carried out, it is typically desired to control either or both the nucleation and the crystal growth rates. In general, during most ceramic processing operations, it is desired to obtain maximum densification without significant crystal growth. Although not wanting to be bound by theory, in general, it is believed in the ceramic art that larger crystal sizes lead to reduced mechanical properties while finer average crystallite sizes lead to improved mechanical properties (e.g., higher strength and higher hardness). In particular, it is very desirable to form ceramics with densities of at least 90, 95, 97, 98, 99, or even at least 100 percent of theoretical density, wherein the average crystal sizes are less than 0. 15 micrometer, or even less than 0.1 micrometer.

In some embodiments of the present invention, the glasses or ceramics comprising glass may be annealed prior to heat-treatment. In such cases annealing is typically done at a temperature less than the Tₓ of the glass for a time from a few second to few hours or even days. Typically, the annealing is done for a period of less than 3 hours, or even less than an hour. Optionally, annealing may also be carried out in atmospheres other than air. Furthermore, different stages (i.e., the nucleation step and the crystal growth step) of the heat-treatment may be carried out under different atmospheres. It is believed that the T_{g} and Tₓ, as well as the Tₓ-T_{g} of glasses according to this invention may shift depending on the atmospheres used during the heat-treatment.

One skilled in the art can determine the appropriate conditions from a Time-Temperature-Transformation (TTT) study of the glass using techniques known in the art. One skilled in the art, after reading the disclosure of the present invention should be able to provide TTT curves for glasses used to make glass-ceramics according to the present invention, determine the appropriate nucleation and/or crystal growth conditions to provide glass-ceramics according to the present invention.

Heat-treatment may occur, for example, by feeding the material directly into a furnace at the elevated temperature. Alternatively, for example, the material may be fed into a furnace at a much lower temperature (e.g., room temperature) and then heated to desired temperature at a predetermined heating rate. It is within the scope of the present invention to conduct heat-treatment in an atmosphere other than air. In some cases it might be even desirable to heat-treat in a reducing atmosphere(s). Also, for, example, it may be desirable to heat-treat under gas pressure as in, for example, hot-isostatic press, or in gas pressure furnace. Although not wanting to be bound by theory, it is believed that atmospheres may affect oxidation states of some of the components of the glasses and glass-ceramics. Such variation in oxidation state can bring about varying coloration of glasses and glass-ceramics. In addition, nucleation and crystallization steps can be affected by atmospheres (e.g., the atmosphere may affect the atomic mobilities of some species of the glasses).

It is also within the scope of the present invention to conduct additional heat-treatment to further improve desirable properties of the material. For example, hot-isostatic pressing may be conducted (e.g., at temperatures from about 900° C. to about 1400° C.) to remove residual porosity, increasing the density of the material.

It is within the scope of the present invention to convert (e.g., crush) the resulting article or heat-treated article to provide particles (e.g., ceramic abrasive particles).

Typically, glass-ceramics are stronger than the amorphous material from which they are formed. Hence, the strength of the material may be adjusted, for example, by the degree to which the amorphous material is converted to crystalline ceramic phase(s). Alternatively, or in addition, the strength of the material may also be affected, for example, by the number of nucleation sites created, which may in turn be used to affect the number, and in turn the size of the crystals of the crystalline phase(s). For additional details regarding forming glass-ceramics, see, for example Glass-Ceramics, P. W. McMillan, Academic Press, Inc., 2^{nd} edition, 1979, the disclosure of which is incorporated herein by reference.

For example, during heat-treatment of some exemplary precursor ceramics for making the ceramics, formation of phases such as La₂Zr₂O₇, and, if ZrO₂ is present, cubic/tetragonal ZrO₂, in some cases monoclinic ZrO₂, may occur at temperatures above about 900° C. Although not wanting to be bound by theory, it is believed that zirconia-related phases are the first phases to nucleate from the amorphous material. Formation of Al₂O₃, ReAlO₃ (wherein Re is at least one rare earth cation), ReAl₁₁O₁₈, Re₃Al5O₁₂, Y₃Al₅O₁₂, etc. phases are believed to generally occur at temperatures above about 925° C. Typically, crystallite size during this nucleation step is on order of nanometers. For example, crystals as small as 10-15 nanometers have been observed. Longer heat-treating temperatures typically lead to the growth of crystallites and progression of crystallization. For at least some embodiments, heat-treatment at about 1250° C. for about 1 hour provides a full crystallization. In generally, heat-treatment times for each of the nucleation and crystal growth steps may range of a few seconds (in some embodiments even less than 5 seconds) to several minutes to an hour or more.

Examples of crystalline phases which may be present in embodiments of ceramics made according to the present invention include: Al₂O₃ (e.g., alpha Al₂O₃), Y₂O₃, REO, HfO₂, ZrO₂ (e.g., cubic ZrO₂ and tetragonal ZrO₂), BaO, CaO, Cr₂O₃, CoO, Fe₂O₃, GeO₂, Li₂O, MgO, MnO, NiO, Na₂O, P₂O₅, Sc₂O₃, SiO2, SrO, TeO₂, TiO₂, V₂O₃, Y₂O₃, ZnO, “complex metal oxides” (including “complex Al₂O₃-metal oxide (e.g., complex Al₂O₃-REO (e.g., ReAlO₃ (e.g., GdAlO₃ LaAlO₃), ReAl₁₁O₁₈ (e.g., LaAl₁₁O₁₈,), and Re₃Al₅O₁₂ (e.g., Dy₃Al₅O₁₂)), complex Al₂O₃.Y₂O₃ (e.g., Y₃Al₅O₁₂), and complex ZrO₂.REO (e.g., La₂Zr₂O₇)), and combinations thereof. Typically, ceramics according to the present invention are free of eutectic microstructure features.

It is also with in the scope of the present invention to substitute a portion of the aluminum cations in a complex Al₂O₃.metal oxide (e.g., complex Al₂O₃.REO and/or complex Al₂O₃.Y₂O₃ (e.g., yttrium aluminate exhibiting a garnet crystal structure)) with other cations. For example, a portion of the Al cations in a complex Al₂O₃.Y₂O₃ may be substituted with at least one cation of an element selected from the group consisting of: Cr, Ti, Sc, Fe, Mg, Ca, Si, Co, and combinations thereof. For example, a portion of the Y cations in a complex Al₂O₃.Y₂O₃ may be substituted with at least one cation of an element selected from the group consisting of: Ce, Dy, Er, Eu, Gd, Ho, La, Lu, Nd, Pr, Sm, Th, Tm, Yb, Fe, Ti, Mn, V, Cr, Co, Ni, Cu, Mg, Ca, Sr, and combinations thereof. Further for example, a portion of the rare earth cations in a complex Al₂O₃.REO may be substituted with at least one cation of an element selected from the group consisting of: Y, Fe, Ti, Mn, V, Cr, Co, Ni, Cu, Mg, Ca, Sr, and combinations thereof. The substitution of cations as described above may affect the properties (e.g. hardness, toughness, strength, thermal conductivity, etc.) of the ceramic.

In some embodiments, amorphous materials used to make ceramics according to a method of the present invention, and ceramics comprising alumina made according to a method of the present invention, contain not more than 30 (in some embodiments, not more than 25, 20, 15, 10, 5, 4, 3, 2, 1, or even zero) percent by weight collectively As₂O₃, B₂O₃, GeO₂, P₂O₅, SiO₂, TeO₂, and V₂O₅, based on the total weight of the amorphous material or ceramic.

In some embodiments, amorphous materials used to make ceramics according to a method of the present invention, and ceramics comprising alumina made according to a method of the present invention, comprise at least 35, 40, 45, 50, 55, 60, 65, 70, 75, 80, 85, or even at least 90% by weight Al₂O₃, based on the total weight of the amorphous material or ceramic. In some embodiments, amorphous materials used to make ceramics according to a method of the present invention, and ceramics comprising alumina made according to a method of the present invention, comprise 20 to at least 90 percent by weight (in some embodiments, 30 to at least 90 percent, 40 to at least 90 percent, 50 to at least 90 percent, or even 60 to at least 90 percent) Al₂O₃; 0 to 50 percent by weight (in some embodiments, 0 to 25 percent; or even 0 to 10 percent) Y₂O₃; and 0 to 50 percent by weight (in some embodiments, 0 to 25 percent; or even 0 to 10 percent) at least one of ZrO₂ or HfO₂, based on the total weight of the amorphous material or ceramic. In some embodiments, such amorphous materials and ceramics comprise at least 30, 40, 50, 60, 70, 75, 80, 85, or even at least 90 percent by weight, or even at least 70 percent by weight Al₂O₃, based on the total weight of the amorphous material or ceramic. In some embodiments, such amorphous materials and ceramics contain not more than 40 (in some embodiments, not more than 35, 30, 25, 20, 15, 10, 5, 4, 3, 2, 1, or even zero) percent by weight collectively SiO₂, B₂O₃, and P₂O₅, based on the total weight of the amorphous material or ceramic. In some embodiments, such amorphous materials and ceramics contain not more than 20 (in some embodiments, not more than 15, 10, 5, or even zero) percent by weight SiO₂ and not more than 20 (in some embodiments, not more than 15, 10, 5, or even zero) zero) percent by weight B₂O₃, based on the total weight of the amorphous material or ceramic.

In some embodiments, amorphous materials used to make ceramics according to a method of the present invention, and ceramics comprising alumina (in some embodiments, alpha alumina) made according to a method of the present invention, comprise 35 to at least (in some embodiments, 40, 50, 60, 70, 75, 80, 85, or even at least 90) percent by weight Al₂O₃; 0 to 50 percent by weight (in some embodiments, 0 to 25 percent; or even 0 to 10 percent) REO; 0 to 50 percent by weight (in some embodiments, 0 to 25 percent; or even 0 to 10 percent) at least one of ZrO₂ or HfO₂, based on the total weight of the amorphous material or ceramic. In some embodiments, such amorphous materials and ceramics comprise at least 35 (in some embodiments, 40, 50, 60, 70, 75, 80, 85, or even at least 90) percent by weight Al₂O₃, based on the total weight of the amorphous material or ceramic. In some embodiments, such amorphous materials and ceramics comprise not more than 40 (in some embodiments, not more than 35, 30, 25, 20, 15, 10, 5, 4, 3, 2, 1, or even zero) zero) percent by weight collectively SiO₂, B₂O₃, and P₂O₅, based on the total weight of the amorphous materials or ceramic. In some embodiments, such amorphous materials and ceramics contain not more than 20 (in some embodiments, not more than 15, 10, 5, or even zero) percent by weight SiO₂ and not more than 20 (in some embodiments, not more than 15, 10, 5, or even zero) percent by weight B₂O₃, based on the total weight of the amorphous material or ceramic.

In some embodiments, amorphous materials used to make ceramics according to a method of the present invention, and ceramics comprising alumina (in some embodiments, alpha alumina) made according to a method of the present invention, comprise 35 to at least 90 percent by weight (in some embodiments, 35 to at least 90 percent, 50 to at least 90 percent, or even 60 to 90 percent) Al₂O₃; 0 to 50 percent by weight (in some embodiments, 0 to 25 percent; or even 0 to 10 percent) Y₂O₃; 0 to 50 percent by weight (in some embodiments, 0 to 25 percent; or even 0 to 10 percent) REO, 0 to 50 percent by weight (in some embodiments, 0 to 25 percent; or even 0 to 10 percent) at least one of ZrO₂ or HfO₂, based on the total weight of the amorphous material or ceramic. In some embodiments, such amorphous materials and ceramics comprise at least 35 (in some embodiments, 40, 50, 60, 70, 75, 80, 85, or even at least 90) percent by weight Al₂O₃, based on the total weight of the amorphous material or ceramic. In some embodiments, such amorphous materials, and ceramics contain not more than 40 (in some embodiments, not more than 35, 30, 25, 20, 15, 10, 5, 4, 3, 2, 1, or even zero) percent by weight collectively SiO₂, B₂O₃, and P₂O₅, based on the total weight of the amorphous material or ceramic. In some embodiments, such amorphous materials and ceramics contain not more than 20 (in some embodiments, not more than 15, 10, 5, or even zero) percent by weight SiO₂ and not more than 20 (in some embodiments, not more than 15, 10, 5, or even zero) percent by weight B₂O₃, based on the total weight of the amorphous material or ceramic.

In some embodiments, amorphous materials used to make ceramics according to a method of the present invention, and ceramics comprising alumina (in some embodiments, alpha alumina) made according to a method of the present invention, comprise at least 75 (in some embodiments at least 80, or even at least 85) percent by weight Al₂O₃, La₂O₃ in a range from 0 to 25 (in some embodiments, 0 to 10, or even 0 to 5) percent by weight, Y₂O₃ in a range from 5 to 25 (in some embodiments, 5 to 20, or even 10 to 20) percent by weight, MgO in a range from 0 to 8 (in some embodiments, 0 to 4, or even 0 to 2) percent by weight, based on the total weight of the amorphous material or ceramic, respectively.

In some embodiments, amorphous materials used to make ceramics according to a method of the present invention, and ceramics comprising alumina (in some embodiments, alpha alumina) made according to a method of the present invention, comprise at least 75 percent (in some embodiments, at least 80, 85, or even at least 90; in some embodiments, in a range from 75 to 90) by weight Al₂O₃, and at least 1 percent (in some embodiments, at least 5, at least 10, at least 15, at least 20, or even 25; in some embodiments, in a range from 10 to 25, 15 to 25) by weight Y₂O₃, based on the total weight of the amorphous material or ceramic, respectively.

In some embodiments, amorphous materials used to make ceramics according to a method of the present invention, and ceramics comprising alumina (in some embodiments, alpha alumina) made according to a method of the present invention, comprise at least 75 (in some embodiments, at least 80, 85, or even at least 90) percent by weight Al₂O₃, and at least 10 (in some embodiments, at least 15, 20 or even at least 25) percent by weight Y₂O₃ based on the total weight of the amorphous material or ceramic, respectively.

In some embodiments, amorphous materials used to make ceramics according to a method of the present invention, and ceramics comprising alumina (in some embodiments, alpha alumina) made according to a method of the present invention, comprise at least 75 (in some embodiments at least 80, or even at least 85) percent by weight Al₂O₃, La₂O₃ in a range from 0.1 to 23.9 percent by weight, Y₂O₃ in a range from 1 to 24.8 percent by weight, MgO in a range from 0.1 to 8 percent by weight, and up to 10 percent by weight SiO₂, based on the total weight of the amorphous material or ceramic, respectively.

In some embodiments, amorphous materials used to make ceramics according to a method of the present invention, and ceramics comprising alumina (in some embodiments, alpha alumina) made according to a method of the present invention, comprise at least 75 (in some embodiments at least 80, 85, or even at least 90) percent by weight Al₂O₃ and SiO₂ in an amount up to 10 (in some embodiments, in a range from 0.5 to 5, 0.5 to 2, or 0.5 to 1) percent by weight, based on the total weight of the amorphous material or ceramic, respectively.

For some embodiments, amorphous materials used to make ceramics according to a method of the present invention, and ceramics comprising alumina (in some embodiments, alpha alumina) made according to a method of the present invention, comprising ZrO₂ and/or HfO₂, the amount of ZrO₂ and/or HfO₂ present may be at least 5, 10, 15, or even at least 20 percent by weight, based on the total weight of the amorphous material or ceramic, respectively.

Some exemplary embodiments of ceramics made according to a method of the present invention comprise or are a glass-ceramic comprising alpha Al₂O₃, crystalline ZrO₂, and a first complex Al₂O₃.Y₂O₃, wherein at least one of the alpha Al₂O₃, the crystalline ZrO₂, or the first complex Al₂O₃.Y₂O₃ has an average crystal size not greater than 150 nanometers. In some embodiments, at least 75 (80, 85, 90, 95, 97, or even at least 99) percent by number of the crystal sizes are not greater than 150 nanometers. In some embodiments, the glass-ceramic further comprises a second, different complex Al₂O₃.Y₂O₃. In some embodiments, the glass-ceramic further comprises a complex Al₂O₃.REO.

Some exemplary embodiments of ceramics made according to a method of the present invention comprise or are a glass-ceramic comprising a first complex Al₂O₃.Y₂O₃, a second, different complex Al₂O₃.Y₂O₃, and crystalline ZrO₂, wherein for at least one of the first complex Al₂O₃.Y₂O₃, the second complex Al₂O₃.Y₂O₃, or the crystalline ZrO₂, at least 90 (in some embodiments, 95, or even 100) percent by number of the crystal sizes thereof are not greater than 200 nanometers. In some embodiments, the glass-ceramic further comprises a second, different complex Al₂O₃.Y₂O₃. In some embodiments, the glass-ceramic further comprises a complex Al₂O₃.REO.

Some exemplary embodiments of ceramics made according to a method of the present invention comprise or are a glass-ceramic comprising alpha Al₂O₃, crystalline ZrO₂, and a first complex Al₂O₃.REO, wherein at least one of the alpha Al₂O₃, the crystalline ZrO₂, or the first complex Al₂O₃.REO has an average crystal size not greater than 150 nanometers. In some embodiments, at least 75 (80, 85, 90, 95, 97, or even at least 99) percent by number of the crystal sizes are not greater than 150 nanometers. In some embodiments, the glass-ceramic further comprises a second, different complex Al₂O₃.REO. In some embodiments, the glass-ceramic further comprises a complex Al₂O₃.Y₂O₃.

Some exemplary embodiments of ceramics made according to a method of the present invention comprise a first complex Al₂O₃.REO, a second, different complex Al₂O₃.REO, and crystalline ZrO₂, wherein for at least one of the first complex Al₂_{O}₃.REO, the second complex Al₂O₃.REO, or the crystalline ZrO₂, at least 90 (in some embodiments, 95, or even 100) percent by number of the crystal sizes thereof are not greater than 200 nanometers). In some embodiments, the glass-ceramic further comprises a complex Al₂O₃.Y₂O₃.

Some exemplary embodiments of ceramics made according to a method of the present invention comprise a first complex Al₂O₃.Y₂O₃, a second, different complex Al₂O₃.Y₂O₃, and crystalline ZrO₂, wherein at least one of the first complex Al₂O₃.Y₂O₃, the second, different complex Al₂O₃.Y₂O₃, or the crystalline ZrO₂ has an average crystal size not greater than 150 nanometers. In some embodiments, at least 75 (80, 85, 90, 95, 97, or even at least 99) percent by number of the crystal sizes are not greater than 150 nanometers. In some embodiments, the glass-ceramic further comprises a second, different complex Al₂O₃.Y₂O₃. In some embodiments, the glass-ceramic further comprises a complex Al₂O₃.REO.

Some exemplary embodiments of ceramics made according to a method of the present invention comprise a first complex Al₂O₃.Y₂O₃, a second, different complex Al₂O₃.Y₂O₃, and crystalline ZrO₂, wherein for at least one of the first complex Al₂O₃.Y₂O₃, the second, different complex Al₂O₃.Y₂O₃, or the crystalline ZrO₂, at least 90 (in some embodiments, 95, or even 100) percent by number of the crystal sizes thereof are not greater than 200 nanometers. In some embodiments, the glass-ceramic further comprises a complex Al₂O₃.REO.

Some exemplary embodiments of ceramics made according to a method of the present invention comprise a first complex Al₂O₃.REO, a second, different complex Al₂O₃.REO, and crystalline ZrO₂, wherein at least one of the first complex Al₂O₃.REO, the second, different complex Al₂O₃.REO, or the crystalline ZrO₂ has an average crystal size not greater than 150 nanometers. In some embodiments, at least 75 (80, 85, 90, 95, 97, or even at least 99) percent by number of the crystal sizes are not greater than 150 nanometers. In some embodiments, the glass-ceramic further comprises a second, different complex Al₂O₃.REO. In some embodiments, the glass-ceramic further comprises a complex Al₂O₃.Y₂O₃.

Some exemplary embodiments of ceramics made according to a method of the present invention comprise a first complex Al₂O₃.REO, a second, different complex Al₂O₃.REO, and crystalline ZrO₂, wherein for at least one of the first complex Al₂O₃.REO, the second, different complex Al₂O₃.REO, or the crystalline ZrO₂, at least 90 (in some embodiments, 95, or even 100) percent by number of the crystal sizes thereof are not greater than 200 nanometers. In some embodiments, the glass-ceramic further comprises a complex Al₂O₃.Y₂O₃.

Typically, ceramics made according to a method of the present invention have x, y, and z dimensions each perpendicular to each other, and wherein each of the x, y, and z dimensions is at least 25 micrometers. In some embodiments, the x, y, and z dimensions is at least 50 micrometers, 75 micrometers, 100 micrometers, 250 micrometers, 500 micrometers, 1000 micrometers, 2000 micrometers, 2500 micrometers, 1 mm, or even at least 5 mm, if coalesced. The x, y, and z dimensions of a material are determined either visually or using microscopy, depending on the magnitude of the dimensions. The reported z dimension is, for example, the diameter of a sphere, the thickness of a coating, or the longest length of a prismatic shape.

The average crystal size can be determined by the line intercept method according to the ASTM standard E 112-96 “Standard Test Methods for Determining Average Grain Size”. The sample is mounted in mounting resin (obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (obtained from Buehler, Lake Bluff, Ill. under the trade designation “ECOMET 3”). The sample is polished for about 3 minutes with a diamond wheel, followed by 5 minutes of polishing with each of 45, 30, 15, 9, 3, and 1-micrometer slurries. The mounted and polished sample is sputtered with a thin layer of gold-palladium and viewed using a scanning electron microscopy (Model JSM 840A from JEOL, Peabody, Mass.). A typical back-scattered electron (BSE) micrograph of the microstructure found in the sample is used to determine the average crystallite size as follows. The number of crystallites that intersect per unit length (N_{L}) of a random straight line drawn across the micrograph are counted. The average crystallite size is determined from this number using the following equation.

$$Average Crystallite Size = \frac{1.5}{{N}_{L} M} ,$$

where N_{L} is the number of crystallites intersected per unit length and M is the magnification of the micrograph.

In some embodiments, ceramics made according to a method of the present invention comprise at least 75, 80, 85, 90, 95, 97, 98, 99, or even 100 percent by volume crystallites, wherein the crystallites have an average size not greater than 1 micrometer. In some embodiments, ceramics made according to a method of the present invention comprise at least 75, 80, 85, 90, 95, 97, 98, 99, or even 100 percent by volume crystallites, wherein the crystallites have an average size not greater than 0.5 micrometer. In some embodiments, ceramics made according to a method of the present invention comprise at least 75, 80, 85, 90, 95, 97, 98, 99, or even 100 percent by volume crystallites, wherein the crystallites have an average size not greater than 0.3 micrometer (in some embodiments, not greater than 0.15 micrometer).

In some embodiments, the (true) density, sometimes referred to as specific gravity, of ceramics made according to a method of the present invention is at least 92%, 95%, 96%, 97%, 98%, 99%, 99.5%, or 100% of theoretical density.

The average hardness of a material can be determined as follows. Sections of the material are mounted in mounting resin (obtained under the trade designation “TRANSOPTIC POWDER” from Buehler, Lake Bluff, Ill.) typically in a cylinder of resin about 2.5 cm in diameter and about 1.9 cm high. The mounted section is prepared using conventional polishing techniques using a polisher (obtained from Buehler, Lake Bluff, Ill. under the trade designation “ECOMET 3”). The sample is polished for about 3 minutes with a diamond wheel, followed by 5 minutes of polishing with each of 45, 30, 15, 9, 3, and 1-micrometer slurries. The microhardness measurements are made using a conventional microhardness tester (obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991), the disclosure of which is incorporated herein by reference. The average hardness is an average of 10 measurements.

Ceramics made according to a method of the present invention have an average hardness of at least 15 GPa, at least 16 GPa, at least 17 GPa, 18 GPa, 19 GPa, or even at least 20 GPa.

In some embodiments, ceramics made according to a method of the present invention comprise at least 75, 80, 85, 90, 91, 92, 93, 94, 95, 96, 97, 98, 99, 99.5, or even 100 percent by volume crystalline ceramic (e.g., alpha alumina). Ceramic abrasive particles made according to a method of the present invention generally comprise at least 75, 80, 85, 90, 91, 92, 93, 94, 95, 96, 97, 98, 99, 99.5, or even 100 percent by volume crystalline ceramic (e.g., alpha alumina).

Ceramic abrasive particles made according to a method of the present invention can be screened and graded using techniques well known in the art, including the use of industry recognized grading standards such as ANSI (American National Standard Institute), FEPA (Federation Europeenne des Fabricants de Products Abrasifs), and JIS (Japanese Industrial Standard). Ceramic abrasive particles made according to a method of the present invention may be used in a wide range of particle sizes, typically ranging in size from about 0.1 to about 5000 micrometers, more typically from about 1 to about 2000 micrometers; desirably from about 5 to about 1500 micrometers, more desirably from about 100 to about 1500 micrometers.

ANSI grade designations include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS400, JIS600, JIS800, JIS1000, JIS1500, JIS2500, JIS4000, JIS6000, JIS8000, and JIS10,000.

After crushing and screening, there will typically be a multitude of different abrasive particle size distributions or grades. These multitudes of grades may not match a manufacturer's or supplier's needs at that particular time. To minimize inventory, it is possible to recycle the off demand grades back into melt to form amorphous material. This recycling may occur after the crushing step, where the particles are in large chunks or smaller pieces (sometimes referred to as “fines”) that have not been screened to a particular distribution.

In another aspect, the present invention provides an abrasive article (e.g., coated abrasive articles, bonded abrasive articles (including vitrified, resinoid, and metal bonded grinding wheels, cutoff wheels, mounted points, and honing stones), nonwoven abrasive articles, and abrasive brushes) comprising a binder and a plurality of abrasive particles, wherein at least a portion of the abrasive particles are ceramic abrasive particles (including where the abrasive particles are agglomerated) made according to a method of the present invention. Methods of making such abrasive articles and using abrasive articles are well known to those skilled in the art. Furthermore, ceramic abrasive particles according to the present invention can be used in abrasive applications that utilize abrasive particles, such as slurries of abrading compounds (e.g., polishing compounds), milling media, shot blast media, vibratory mill media, and the like. It is also within the scope of the present invention to make agglomerate abrasive grains each comprising a plurality of ceramic abrasive particles made according to a method of the present invention bonded together via a binder.

In some embodiments at least 5, 10, 15, 20, 25, 30, 35, 40, 45, 50 55, 60, 65, 70, 75, 80, 85, 90, 95, or even 100 percent by weight of the abrasive particles in an abrasive article are ceramic abrasive particles made according to a method of the present invention, based on the total weight of the abrasive particles in the abrasive article.

Coated abrasive articles generally include a backing, abrasive particles, and at least one binder to hold the abrasive particles onto the backing. The backing can be any suitable material, including cloth, polymeric film, fibre, nonwoven webs, paper, combinations thereof, and treated versions thereof. The binder can be any suitable binder, including an inorganic or organic binder (including thermally curable resins and radiation curable resins). The abrasive particles can be present in one layer or in two layers of the coated abrasive article.

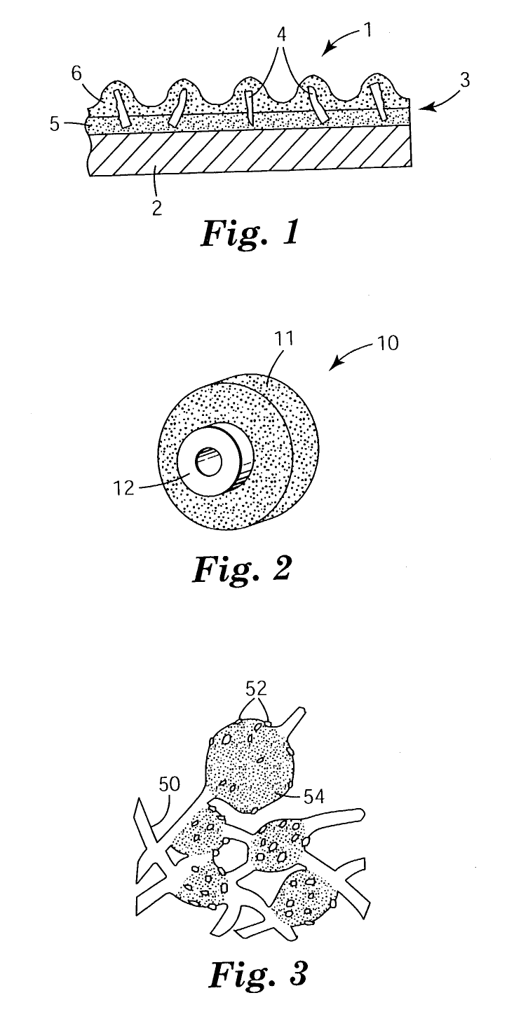

An example of a coated abrasive article according to the present invention is depicted in FIG. 1. Referring to FIG. 1, coated abrasive article 1 has a backing (substrate) 2 and abrasive layer 3. Abrasive layer 3 includes ceramic abrasive particles made according to a method of the present invention 4 secured to a major surface of backing 2 by make coat 5 and size coat 6. In some instances, a supersize coat (not shown) is used.

Bonded abrasive articles typically include a shaped mass of abrasive particles held together by an organic, metallic, or vitrified binder. Such shaped mass can be, for example, in the form of a wheel, such as a grinding wheel or cutoff wheel. The diameter of grinding wheels typically is about 1 cm to over 1 meter; the diameter of cut off wheels about 1 cm to over 80 cm (more typically 3 cm to about 50 cm). The cut off wheel thickness is typically about 0.5 mm to about 5 cm, more typically about 0.5 mm to about 2 cm. The shaped mass can also be in the form, for example, of a honing stone, segment, mounted point, disc (e.g. double disc grinder) or other conventional bonded abrasive shape. Bonded abrasive articles typically comprise about 3-50% by volume bond material, about 30-90% by volume abrasive particles (or abrasive particle blends), up to 50% by volume additives (including grinding aids), and up to 70% by volume pores, based on the total volume of the bonded abrasive article.

An exemplary grinding wheel is shown in FIG. 2. Referring to FIG. 2, grinding wheel 10 is depicted, which includes ceramic abrasive particles made according to a method of the present invention 11, molded in a wheel and mounted on hub 12.

Nonwoven abrasive articles typically include an open porous lofty polymer filament structure having abrasive particles distributed throughout the structure and adherently bonded therein by an organic binder. Examples of filaments include polyester fibers, polyamide fibers, and polyaramid fibers. An exemplary nonwoven abrasive article is shown in FIG. 3. Referring to FIG. 3, a schematic depiction, enlarged about 100×, of a typical nonwoven abrasive article is shown, and comprises fibrous mat 50 as a substrate, onto which ceramic abrasive particles made according to a method of the present invention 52 are adhered by binder 54.

Useful abrasive brushes include those having a plurality of bristles unitary with a backing (see, e.g., U.S. Pat. Nos. 5,427,595 (Pihl et al.), 5,443,906 (Pihl et al.), 5,679,067 (Johnson et al.), and 5,903,951 (lonta et al.), the disclosure of which is incorporated herein by reference). Desirably, such brushes are made by injection molding a mixture of polymer and abrasive particles.

Suitable organic binders for making abrasive articles include thermosetting organic polymers. Examples of suitable thermosetting organic polymers include phenolic resins, urea-formaldehyde resins, melamine-formaldehyde resins, urethane resins, acrylate resins, polyester resins, aminoplast resins having pendant α,β-unsaturated carbonyl groups, epoxy resins, acrylated urethane, acrylated epoxies, and combinations thereof. The binder and/or abrasive article may also include additives such as fibers, lubricants, wetting agents, thixotropic materials, surfactants, pigments, dyes, antistatic agents (e.g., carbon black, vanadium oxide, graphite, etc.), coupling agents (e.g., silanes, titanates, zircoaluminates, etc.), plasticizers, suspending agents, and the like. The amounts of these optional additives are selected to provide the desired properties. The coupling agents can improve adhesion to the abrasive particles and/or filler. The binder chemistry may thermally cured, radiation cured or combinations thereof. Additional details on binder chemistry may be found in U.S. Pat. Nos. 4,588,419 (Caul et al.), 4,751,138 (Tumey et al.), and 5,436,063 (Follett et al.), the disclosures of which are incorporated herein by reference.

More specifically with regard to vitrified bonded abrasives, vitreous bonding materials, which exhibit an amorphous structure and are typically hard, are well known in the art. In some cases, the vitreous bonding material includes crystalline phases. Bonded, vitrified abrasive articles according to the present invention may be in the shape of a wheel (including cut off wheels), honing stone, mounted pointed or other conventional bonded abrasive shape. In some embodiments, a vitrified bonded abrasive article is in the form of a grinding wheel.

Examples of metal oxides that are used to form vitreous bonding materials include: silica, silicates, alumina, soda, calcia, potassia, titania, iron oxide, zinc oxide, lithium oxide, magnesia, boria, aluminum silicate, borosilicate glass, lithium aluminum silicate, combinations thereof, and the like. Typically, vitreous bonding materials can be formed from composition comprising from 10 to 100% glass frit, although more typically the composition comprises 20% to 80% glass frit, or 30% to 70% glass frit. The remaining portion of the vitreous bonding material can be a non-frit material. Alternatively, the vitreous bond may be derived from a non-frit containing composition. Vitreous bonding materials are typically matured at a temperature(s) in a range of about 700° C. to about 1500° C., usually in a range of about 800° C. to about 1300° C., sometimes in a range of about 900° C. to about 1200° C., or even in a range of about 950° C. to about 1100° C. The actual temperature at which the bond is matured depends, for example, on the particular bond chemistry.

In some embodiments, vitrified bonding materials include those comprising silica, alumina (desirably, at least 10 percent by weight alumina), and boria (desirably, at least 10 percent by weight boria). In most cases the vitrified bonding material further comprise alkali metal oxide(s) (e.g., Na₂O and K₂O) (in some cases at least 10 percent by weight alkali metal oxide(s)).

Binder materials may also contain filler materials or grinding aids, typically in the form of a particulate material. Typically, the particulate materials are inorganic materials. Examples of useful fillers for this invention include: metal carbonates (e.g., calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., talc, clays, (montmorillonite) feldspar, mica, calcium silicate, calcium metasilicate, sodium aluminosilicate, sodium silicate) metal sulfates (e.g., calcium sulfate, barium sulfate, sodium sulfate, aluminum sodium sulfate, aluminum sulfate), gypsum, vermiculite, wood flour, aluminum trihydrate, carbon black, metal oxides (e.g., calcium oxide (lime), aluminum oxide, titanium dioxide), and metal sulfites (e.g., calcium sulfite).

In general, the addition of a grinding aid increases the useful life of the abrasive article. A grinding aid is a material that has a significant effect on the chemical and physical processes of abrading, which results in improved performance. Although not wanting to be bound by theory, it is believed that a grinding aid(s) will (a) decrease the friction between the abrasive particles and the workpiece being abraded, (b) prevent the abrasive particles from “capping” (i.e., prevent metal particles from becoming welded to the tops of the abrasive particles), or at least reduce the tendency of abrasive particles to cap, (c) decrease the interface temperature between the abrasive particles and the workpiece, or (d) decreases the grinding forces.

Grinding aids encompass a wide variety of different materials and can be inorganic or organic based. Examples of chemical groups of grinding aids include waxes, organic halide compounds, halide salts and metals and their alloys. The organic halide compounds will typically break down during abrading and release a halogen acid or a gaseous halide compound. Examples of such materials include chlorinated waxes like tetrachloronaphtalene, pentachloronaphthalene, and polyvinyl chloride. Examples of halide salts include sodium chloride, potassium cryolite, sodium cryolite, ammonium cryolite, potassium tetrafluoroboate, sodium tetrafluoroborate, silicon fluorides, potassium chloride, and magnesium chloride. Examples of metals include, tin, lead, bismuth, cobalt, antimony, cadmium, and iron titanium. Other miscellaneous grinding aids include sulfur, organic sulfur compounds, graphite, and metallic sulfides. It is also within the scope of the present invention to use a combination of different grinding aids, and in some instances this may produce a synergistic effect.

Grinding aids can be particularly useful in coated abrasive and bonded abrasive articles. In coated abrasive articles, grinding aid is typically used in the supersize coat, which is applied over the surface of the abrasive particles. Sometimes, however, the grinding aid is added to the size coat. Typically, the amount of grinding aid incorporated into coated abrasive articles are about 50-300 g/m² (desirably, about 80-160 g/m²). In vitrified bonded abrasive articles grinding aid is typically impregnated into the pores of the article.

The abrasive articles can contain 100% ceramic abrasive particles made according to a method of the present invention, or blends of such abrasive particles with other abrasive particles and/or diluent particles. However, at least about 2% by weight, desirably at least about 5% by weight, and more desirably about 30-100% by weight, of the abrasive particles in the abrasive articles should be ceramic abrasive particles made according to a method of the present invention. In some instances, ceramic abrasive particles according the present invention may be blended with another abrasive particles and/or diluent particles at a ratio between 5 to 75% by weight, about 25 to 75% by weight about 40 to 60% by weight, or about 50% to 50% by weight (i.e., in equal amounts by weight). Examples of suitable conventional abrasive particles include fused aluminum oxide (including white fused alumina, heat-treated aluminum oxide and brown aluminum oxide), silicon carbide, boron carbide, titanium carbide, diamond, cubic boron nitride, garnet, fused alumina-zirconia, and sol-gel-derived abrasive particles, and the like. The sol-gel-derived abrasive particles may be seeded or non-seeded. Likewise, the sol-gel-derived abrasive particles may be randomly shaped or have a shape associated with them, such as a rod or a triangle. Examples of sol gel abrasive particles include those described U.S. Pat. Nos. 4,314,827 (Leitheiser et al.), 4,518,397 (Leitheiser et al.), 4,623,364 (Cottringer et al.), 4,744,802 (Schwabel), 4,770,671 (Monroe et al.), 4,881,951 (Wood et al.), 5,011,508 (Wald et al.), 5,090,968 (Pellow), 5,139,978 (Wood), 5,201,916 (Berg et al.), 5,227,104 (Bauer), 5,366,523 (Rowenhorst et al.), 5,429,647 (Larmie), 5,498,269 (Larmie), and 5,551,963 (Larmie), the disclosures of which are incorporated herein by reference. Additional details concerning sintered alumina abrasive particles made by using alumina powders as a raw material source can also be found, for example, in U.S. Pat. Nos. 5,259,147 (Falz), 5,593,467 (Monroe), and 5,665,127 (Moltgen), the disclosures of which are incorporated herein by reference. Additional details concerning fused abrasive particles, can be found, for example, in U.S. Pat. Nos. 1,161,620 (Coulter), 1,192,709 (Tone), 1,247,337 (Saunders et al.), 1,268,533 (Allen), and 2,424,645 (Baumann et al.) 3,891,408 (Rowse et al.), 3,781,172 (Pett et al.), 3,893,826 (Quinan et al.), 4,126,429 (Watson), 4,457,767 (Poon et al.), 5,023,212 (Dubots et. al), 5,143,522 (Gibson et al.), and 5,336,280 (Dubots et. al), and applications having U.S. Ser. Nos. 09/495,978, 09/496,422, 09/496,638, and 09/496,713, each filed on Feb. 2, 2000, and, Ser. Nos. 09/618,876, 09/618,879, 09/619,106, 09/619,191, 09/619,192, 09/619,215, 09/619,289, 09/619,563, 09/619,729, 09/619,744, and 09/620,262, each filed on Jul. 19, 2000, Ser. No. 09/704,843, filed Nov. 2, 2000, and Ser. No. 09/772,730, filed Jan. 30, 2001, the disclosures of which are incorporated herein by reference. Additional details concerning ceramic abrasive particles, can be found, for example, in applications having U.S. Ser. Nos. 09/922,526, 09/922,527, 09/922,528, and 09/922,530, filed Aug. 2, 2001, now abandoned, Ser. Nos. 10/211,597, 10/211,638, 10/211,629, 10/211,598, 10/211,630, 10/211,639, 10/211,034, 10/211,044, 10/211,628, 10/211,491, 10/211,640, and 10/211,684, each filed Aug. 2, 2002, and ______ (Attorney Docket Nos. 58235US002, 58353US002, 58352US002, and 58257US002), filed the same date as the instant application, the disclosures of which are incorporated herein by reference. In some instances, blends of abrasive particles may result in an abrasive article that exhibits improved grinding performance in comparison with abrasive articles comprising 100% of either type of abrasive particle.

If there is a blend of abrasive particles, the abrasive particle types forming the blend may be of the same size. Alternatively, the abrasive particle types may be of different particle sizes. For example, the larger sized abrasive particles may be ceramic abrasive particles made according to a method of the present invention, with the smaller sized particles being another abrasive particle type. Conversely, for example, the smaller sized abrasive particles may be ceramic abrasive particles made according to a method of the present invention, with the larger sized particles being another abrasive particle type.

Examples of suitable diluent particles include marble, gypsum, flint, silica, iron oxide, aluminum silicate, glass (including glass bubbles and glass beads), alumina bubbles, alumina beads and diluent agglomerates. Ceramic abrasive particles made according to a method of the present invention can also be combined in or with abrasive agglomerates. Abrasive agglomerate particles typically comprise a plurality of abrasive particles, a binder, and optional additives. The binder may be organic and/or inorganic. Abrasive agglomerates may be randomly shape or have a predetermined shape associated with them. The shape may be a block, cylinder, pyramid, coin, square, or the like. Abrasive agglomerate particles typically have particle sizes ranging from about 100 to about 5000 micrometers, typically about 250 to about 2500 micrometers. Additional details regarding abrasive agglomerate particles may be found, for example, in U.S. Pat. Nos. 4,311,489 (Kressner), 4,652,275 (Bloecher et al.), 4,799,939 (Bloecher et al.), 5,549,962 (Holmes et al.), and 5,975,988 (Christianson), and applications having U.S. Ser. Nos. 09/688,444 and 09/688,484, filed Oct. 16, 2000, 09/688,444, Ser. Nos. 09/688,484, 09/688,486, filed Oct. 16, 2000, and Ser. Nos. 09/971,899, 09/972,315, and 09/972,316, filed Oct. 5, 2001, the disclosures of which are incorporated herein by reference.

The abrasive particles may be uniformly distributed in the abrasive article or concentrated in selected areas or portions of the abrasive article. For example, in a coated abrasive, there may be two layers of abrasive particles. The first layer comprises abrasive particles other than ceramic abrasive particles made according to a method of the present invention, and the second (outermost) layer comprises ceramic abrasive particles made according to a method of the present invention. Likewise in a bonded abrasive, there may be two distinct sections of the grinding wheel. The outermost section may comprise ceramic abrasive particles made according to a method of the present invention, whereas the innermost section does not. Alternatively, ceramic abrasive particles made according to a method of the present invention may be uniformly distributed throughout the bonded abrasive article.

Further details regarding coated abrasive articles can be found, for example, in U.S. Pat. Nos. 4,734,104 (Broberg), 4,737,163 (Larkey), 5,203,884 (Buchanan et al.), 5,152,917 (Pieper et al.), 5,378,251 (Culler et al.), 5,417,726 (Stout et al.), 5,436,063 (Follett et al.), 5,496,386 (Broberg et al.), 5,609,706 (Benedict et al.), 5,520,711 (Helmin), 5,954,844 (Law et al.), 5,961,674 (Gagliardi et al.), and 5,975,988 (Christinason), the disclosures of which are incorporated herein by reference. Further details regarding bonded abrasive articles can be found, for example, in U.S. Pat. Nos. 4,543,107 (Rue), 4,741,743 (Narayanan et al.), 4,800,685 (Haynes et al.), 4,898,597 (Hay et al.), 4,997,461 (Markhoff-Matheny et al.), 5,037,453 (Narayanan et al.), 5,110,332 (Narayanan et al.), and 5,863,308 (Qi et al.) the disclosures of which are incorporated herein by reference. Further details regarding vitreous bonded abrasives can be found, for example, in U.S. Pat. Nos. 4,543,107 (Rue), 4,898,597 (Hay et al.), 4,997,461 (Markhoff-Matheny et al.), 5,094,672 (Giles Jr. et al.), 5,118,326 (Sheldon et al.), 5,131,926(Sheldon et al.), 5,203,886 (Sheldon et al.), 5,282,875 (Wood et al.), 5,738,696 (Wu et al.), and 5,863,308 (Qi), the disclosures of which are incorporated herein by reference. Further details regarding nonwoven abrasive articles can be found, for example, in U.S. Pat. No. 2,958,593 (Hoover et al.), the disclosure of which is incorporated herein by reference.

Methods for abrading with ceramic abrasive particles made according to a method of the present invention range of snagging (i.e., high pressure high stock removal) to polishing (e.g., polishing medical implants with coated abrasive belts), wherein the latter is typically done with finer grades (e.g., ANSI 220 and finer) of abrasive particles. The abrasive particle may also be used in precision abrading applications, such as grinding cam shafts with vitrified bonded wheels. The size of the abrasive particles used for a particular abrading application will be apparent to those skilled in the art.

Abrading with ceramic abrasive particles made according to the present invention may be done dry or wet. For wet abrading, the liquid may be introduced supplied in the form of a light mist to complete flood. Examples of commonly used liquids include: water, water-soluble oil, organic lubricant, and emulsions. The liquid may serve to reduce the heat associated with abrading and/or act as a lubricant. The liquid may contain minor amounts of additives such as bactericide, antifoaming agents, and the like.

Ceramic abrasive particles made according to a method of the present invention may be useful, for example, to abrade workpieces such as aluminum metal, carbon steels, mild steels, tool steels, stainless steel, hardened steel, titanium, glass, ceramics, wood, wood-like materials (e.g., plywood and particle board), paint, painted surfaces, organic coated surfaces and the like. The applied force during abrading typically ranges from about 1 to about 100 kilograms.

Advantages and embodiments of this invention are further illustrated by the following examples, but the particular materials and amounts thereof recited- in these examples, as well as other conditions and details, should not be construed to unduly limit this invention. All parts and percentages are by weight unless otherwise indicated. Unless otherwise stated, all examples contained no significant amount of SiO₂, B₂O₃, P₂O₅, GeO₂, TeO₂, As₂O₃, and V₂O₅.

### EXAMPLES 1-3

A 250-ml polyethylene bottle (7.3-cm diameter) was charged with a 50-gram mixture of various powders (as specified for each example in Table 1 (below); using the raw material sources reported in Table 2, (below)), 75 grams of isopropyl alcohol, and 200 grams of alumina milling media (cylindrical in shape, both height and diameter of 0.635 cm; 99.9% alumina; obtained from Coors, Golden Colo.).

TABLE 1

| | | Oxide | | Glass | |
|---|---|---|---|---|---|
| | | equivalent* of | % | transition | Glass |
| | Raw material | the components, | Amorphous | temperature, | Crystallization, |
| Example | amounts, g | % by weight | yield | T_{g}, ° C. | Tₓ, ° C. |
| 1 | Al₂O₃: 19.3 | Al₂O₃: 38.5 | 95 | 870 | 932 |
| | La₂O₃: 21.25 | La₂O₃: 42.5 | | | |
| | ZrO₂: 9.5 | ZrO₂: 19 | | | |
| 2 | Al₂O₃: 16 | Al₂O₃: 55.7 | 93 | 906 | 934 |
| | Al: 8.5 | | | | |
| | Y₂O₃: 16.5 | Y₂O₃: 28.7 | | | |
| | ZrO₂: 9 | ZrO₂: 15.6 | | | |
| 3 | Al₂O₃: 19.6 | AL₂O₃: 66.0 | 96 | 893 | 931 |
| | Al: 10.4 | | | | |
| | Y₂O₃: 20.2 | Y₂O₃: 34.0 | | | |

*i.e., the relative amount of oxide when the Al metal is converted to Al₂O₃

TABLE 2

| Raw Material | Source |
|---|---|
| Alumina (Al₂O₃) | Obtained from Alcoa Industrial Chemicals, |
| particles | Bauxite, AR, under the trade designation |
| | “Al6SG”, average particle size 0.4 micrometer |
| Aluminum (Al) | Obtained from Alfa Aesar, Ward Hill, MA, −325 |
| particles | mesh particle size. |
| Lanthanum oxide | Obtained from Molycorp Inc., Mountain Pass, CA |
| (La₂O₃) particles | and calcined at 700° C. for 6 hours prior to batch |
| | mixing |
| Yttrium oxide | Obtained from H.C. Stark Newton, MA |
| (Y₂O₃) particles | |
| Zirconium oxide | Obtained from Zirconia Sales, Inc. of Marietta, GA |
| (ZRO₂) particles | under the trade designation “DK-2”, average |
| | particle size 2 micrometer. |

The contents of the polyethylene bottle were milled for 16 hours at 60 revolutions per minute (rpm). After the milling, the milling media were removed and the slurry was poured onto a warm (about 75° C.) glass (“PYREX”) pan in a layer, and allowed to dry and cool. Due to the relatively thin layer of material (i.e., about 3 mm thick) and the warm pan, the slurry formed a cake within 5 minutes, and dried in about 30 minutes. The dried mixture was ground by screening through a 70-mesh screen (212-micrometer opening size) with the aid of a paintbrush to form the feed particles.

The resulting screened particles were fed slowly (about 0.5 gram/minute) into a hydrogen/oxygen torch flame which melted the particles and carried them directly into a 19-liter (5-gallon) cylindrical container (30 centimeters (cm) diameter by 34 cm height) of continuously circulating, turbulent water (20° C.) to rapidly quench the molten droplets. The torch was a Bethlehem bench burner PM2D Model B obtained from Bethlehem Apparatus Co., Hellertown, Pa. Hydrogen and oxygen flow rates for the torch were as follows. For the inner ring, the hydrogen flow rate was 8 standard liters per minute (SLPM) and the oxygen flow rate was 3.5 SLPM. For the outer ring, the hydrogen flow rate was 23 SLPM and the oxygen flow rate was 12 SLPM. The angle at which the flame hit the water was about 45°, and the flame length, burner to water surface, was about 18 centimeters (cm). The resulting (quenched) beads were collected in a pan and dried at 110° C. in an electrically heated furnace till dried (about 30 minutes). The bead particles were spherical in shape and varied in size from a few micrometers up to about 250 micrometers, and were either transparent (i.e., amorphous) and/or opaque (i.e., crystalline), varying within a sample. Amorphous materials (including glassy materials) are typically predominantly transparent due to the lack of light scattering centers such as crystal boundaries, while the crystalline particles are opaque due to light scattering effects of the crystal boundaries. Until proven to be amorphous and glass by Differential Thermal Analysis (DTA), the transparent flame-formed beads were considered to be only amorphous.

A percent amorphous yield was calculated (for each Example) from the resulting flame-formed beads using a −100+120 mesh size fraction (i.e., the fraction collected between 150-micrometer opening size and 125-micrometer opening size screens). The measurements were done in the following manner. A single layer of beads was spread out upon a glass slide. The beads were observed using an optical microscope. Using the crosshairs in the optical microscope eyepiece as a guide, beads that lay horizontally coincident with crosshair along a straight line were counted either amorphous or crystalline depending on their optical clarity. A total of 500 beads were counted and a percent amorphous yield was determined by the amount of amorphous beads divided by total beads counted. The amorphous yield data for the flame formed beads of Examples 1-3 are reported in Table 1, above.

The phase composition (glass/amorphous/crystalline) of the beads for each batch was determined through Differential Thermal Analysis (DTA). The material was classified as amorphous if the corresponding DTA trace of the material contained an exothermic crystallization event (Tₓ). If the same trace also contained an endothermic event (T_{g}) at a temperature lower than Tₓ it was considered to consist of a glass phase. If the DTA trace of the material contained no such events, it was considered to contain crystalline phases.

Differential thermal analysis (DTA) was conducted on beads of Examples 1-3 using the following method. A DTA run was made (using an instrument obtained from Netzsch Instruments, Selb, Germany under the trade designation “NETZSCH STA 409 DTA/TGA”) using a −140+170 mesh size fraction (i.e., the fraction collected between 105-micrometer opening size and 90-micrometer opening size screens). An amount of each screened sample was placed in a 100-microliter Al₂O₃ sample holder. Each sample was heated in static air at a rate of 10° C./minute from room temperature (about 25° C.) to 1100° C.

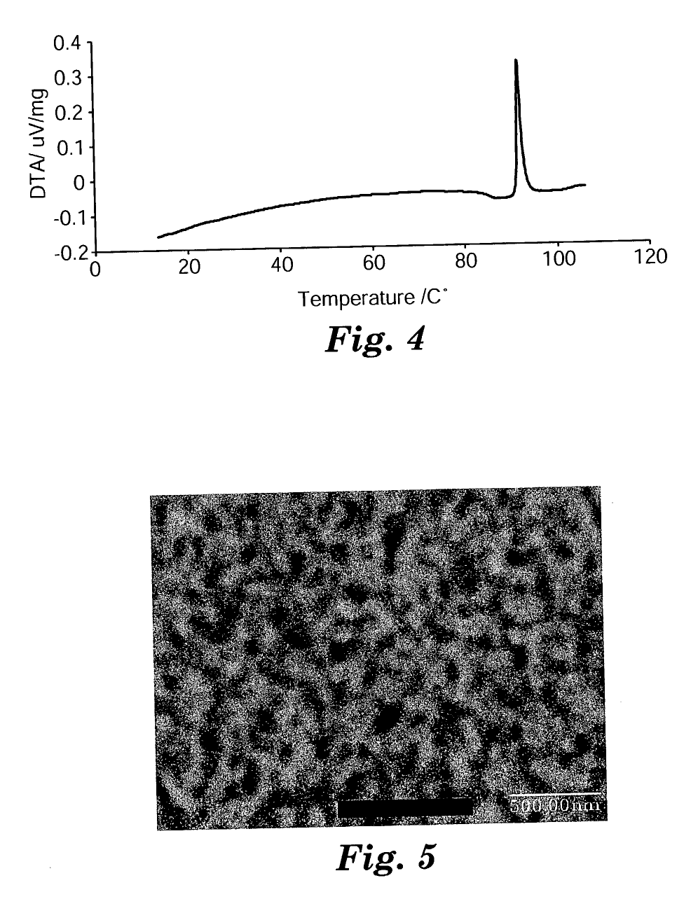

The DTA trace of the beads prepared in Example 1, is shown in FIG. 4, exhibited an endothermic event at a temperature of about 870° C., as evidenced by a downward change in the curve of the trace. It is believed this event was due to the glass transition (T_{g}) of the glass material. The same material exhibited an exothermic event at a temperature of about 932° C., as evidenced by a sharp peak in the trace. It is believed that this event was due to the crystallization (Tₓ) of the material. Hence, the material was determined to be glass. The corresponding glass transition (T_{g}) and crystallization (Tₓ) temperatures for Examples 1-3 are reported in Table 1, above. About 250 grams of the glass beads of Example 1-3 were encapsulated (i.e., canned) in stainless steel foils, and sealed under vacuum. The encapsulated beads were then placed in a Hot Isostatic Press (HIP) (obtained form American Isostatic Presses, Inc., Columbus, Ohio under the trade designation “IPS EAGLE-6”). The HIPing was carried out at a peak temperature of 1000° C., and at about 3000 atm pressure of argon gas. The HIP furnace was first ramped up to 750° C. at 10° C./minute, then from 750° C. to 980° C. at 25° C./minute. The temperature was maintained at 980° C. for 20 minutes, and was then increased to 1000° C. After 10 minutes at 1000° C. the power was turned off, and the furnace allowed to cool. The argon gas pressure was applied at a rate of 37.5 atm/minute. Argon gas pressure reached 3000 atm when the temperature of the furnace was 750° C. This pressure was maintained until the temperature of the furnace was allowed to cool down to about 750° C. The pressure was released at a rate of 30 atm/minutes. The resulting disks, about 7 cm in diameter and 2 cm in thickness, were crushed first by using a hammer into about 1 cm size pieces and then by using a “Chipmunk” jaw crusher (Type VD, manufactured by BICO Inc., Burbank, Calif.) into smaller particles and screened to provide a −20+30 mesh fraction corresponding to particle sizes ranging from 600 micrometer to 850 micrometer. The crushed and screened particles retained their transparency indicating that during HIPing of the beads, and crushing and screening of the discs no significant crystallization event took place.

The density of the −20+30 mesh fraction was measured using a gas pycnometer (obtained from Micromeritics, Norcross, Ga., under the trade designation “ACCUPYC 1330”). The density of the particles for Examples 1-3 are reported in Table 4, above.

About 50 grams of the −20+30 mesh glass particles for each of Examples 1-3 were crystallized by heat-treating. The heat-treatments were carried out at temperatures in a range between the corresponding crystallization temperature, Tₓ of the glassy particles and no higher than 1250° C., for a time not exceeding 1 hour. The heat-treatments were either in air at about 1 atm. (i.e., atmospheric pressure), vacuum or under a flowing argon atmosphere. For the samples heat-treated in air, either a stationary electrically heated furnace (obtained from CM Inc., Bloomfield, N.J.) or a rotary tube furnace (8.9 cm inner diameter, 1.32 meter long silicon carbide tube, inclined at 3 degrees angle with respect to the horizontal, rotating at 3 rpms, resulting in a residence time of about 7.5 minutes in the hot zone. For Examples 1b and 3c, the material was passed through the tube furnace two times and four times, respectively, to provide the reported heat-treatment times. For heat-treatments in vacuum (0.25 atm) or in controlled gas atmospheres (flowing gas blanket atmosphere), with a backpressure of about 1.35 atm.), a resistively heated graphite furnace (obtained from Thermal Technology Inc., Santa Rosa, Calif.) was used.

A summary of the heat-treatment conditions for particles of Examples 1-3 are reported in Table 3, below.

TABLE 3

| Example | Temperature, ° C. | Time, min | Atmosphere | Furnace type |
|---|---|---|---|---|
| 1a | 1200 | 15 | Air | Stationary |
| 1b | 1250 | 15 | Air | Rotary |
| 2a | 1150 | 60 | Air | Stationary |
| 2b | 1250 | 30 | Vacuum | Stationary |
| 3a | 1250 | 30 | Vacuum | Stationary |
| 3b | 1250 | 15 | Air | Stationary |
| 3c | 1250 | 30 | Air | Rotary |
| 3d | 1250 | 60 | Argon | Stationary |
| 3e | 1200 | 30 | Helium | Stationary |

The resulting heat-treated were opaque as observed using an optical microscope (prior to heat-treatment, the particles were transparent). The opacity of the heat-treated particles is believed to be a result of the crystallization of the particles. Glassy materials are typically predominantly transparent due to the lack of light scattering centers such as crystal boundaries, while the crystalline materials are opaque due to light scattering effects of the crystal boundaries.

The density of a portion of the heat-treated crystalline particles were measured as described above, and are reported in Table 4, below.

TABLE 4

| | | Average | Glass | |
|---|---|---|---|---|
| | Average | crystallite size, | density, | Crystallized |
| Example | hardness, GPa | nm | g/cm³ | density, g/cm³ |
| 1a | 17.8 | 113 | 5.06 | 5.21 |
| 1b | 19.0 | 132 | 5.06 | 5.21 |
| 2a | 17.7 | 140 | 4.29 | — |
| 2b | 18.5 | 148 | 4.29 | 4.40 |
| 3a | 19.8 | 148 | 4.15 | 4.27 |
| 3b | 18.6 | 129 | 4.15 | — |
| 3c | 18.9 | 131 | 4.15 | 4.21 |
| 3d | 18.6 | 142 | 4.15 | 4.23 |
| 3e | 19.5 | 126 | 4.15 | — |

The crystallized particles from each heat-treatment were mounted in mounting resin (such as that obtained under the trade designation “TRANSOPTIC POWDER” from Buehler, Lake Bluff, Ill.) in a cylinder of resin about 2.5 cm in diameter and about 1.9 cm high. The mounted section was prepared using conventional polishing techniques using a polisher (such as that obtained from Buehler, Lake Bluff, Ill. under the trade designation “ECOMET 3”). The sample was polished for about 3 minutes with a diamond wheel, followed by 5 minutes of polishing with each of 45, 30, 15, 9, 3, and 1-micrometer slurries. The microhardness measurements are made using a conventional microhardness tester (such as that obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991), the disclosure of which is incorporated herein by reference. The average hardness values (based on an average of 10 measurements) for Examples 1-3 are reported in Table 4, above.

The mounted, polished samples used for the hardness measurements were sputtered with a thin layer of gold-palladium and viewed using a scanning electron microscopy (SEM) (Model JSM 840A from JOEL, Peabody, Mass.). The average crystallite size was determined by the line intercept method according to the ASTM standard E 112-96 “Standard Test Methods for Determining Average Grain Size”. A typical Back Scattered Electron (BSE) micrograph of the microstructure found in the sample was used to determine the average crystallite size as follows. The number of crystallites that intersected per unit length (N_{L}) of a random line were drawn across the micrograph was counted. The average crystallite size is then determined from this number using the following equation.

$$Average Crystallite Size = \frac{1.5}{{N}_{L} M} ,$$

where N_{L} is the number of crystallites intersected per unit length and M is the magnification of the micrograph. A BSE digital micrograph of Example 3 is shown in FIG. 5.

The measured average crystallite size for Examples 1-3 are reported in Table 4, above.

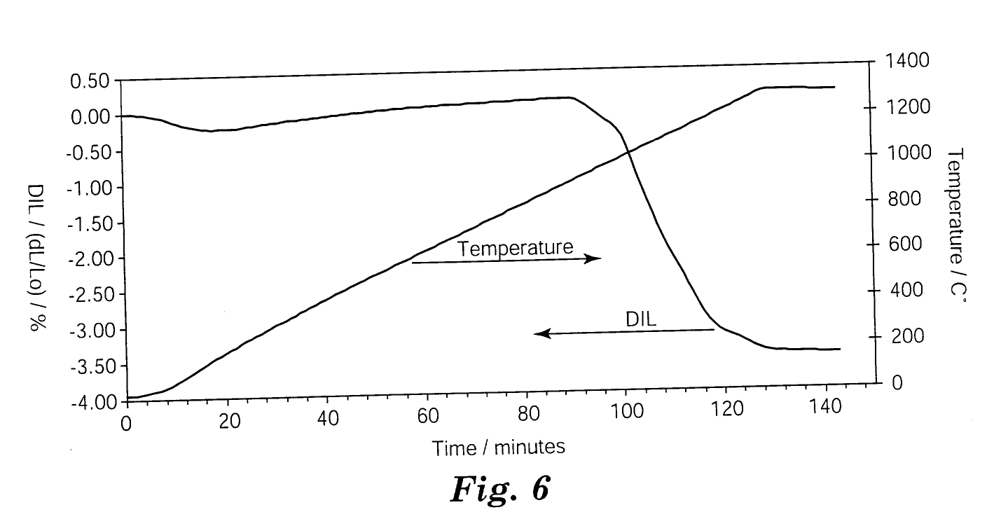

A dilatometer trace was conducted to measure linear shrinkage of Example 1 during crystallization. The trace was conducted (using an instrument obtained from Netzsch Instruments, Selb, Germany under the trade designation “NETZSCH STA 409 DTA/TGA”) using a rectangular bar (about 7 mm×3 mm×3 mm) sectioned from the HIPped Example 1 material. The sample was heated in static air at 10° C./min. from room temperature to 1300° C. and held at 1300° C. for 15 minutes. The dilatometer trace, which in FIG. 6, exhibited shrinkage at about 925° C., as evidence by a downward change in the curve of the trace. The shrinkage stopped at about 1300° C., as evidenced by the leveling in the curve of the trace. The total change in length of the Example 1 sample was -3.5 percent of the original length.

### EXAMPLE 4

A polyurethane-lined mill was charged with 819.6 grams of alumina powder (obtained from Condea Vista, Tucson, Ariz. under the trade designation “APA-0.5”), 818 grams of lanthanum oxide powder (obtained from Molycorp, Inc.), 362.4 grams of yttria-stabilized zirconium oxide powder (with a nominal composition of 94.6 wt % ZrO₂ (+HfO₂) and 5.4 wt. % Y₂O₃; obtained under the trade designation “HSY-3” from Zirconia Sales, Inc. of Marietta, Ga.), 1050 grams of distilled water and about 2000 grams of milling media (obtained from Tosoh Ceramics, Division of Bound Brook, N.J., under the trade designation “YTZ”). The 24 cm diameter mill was milled for 4 hours at about 120 rpm. After the milling, the milling media were removed and the slurry was poured onto a glass (“PYREX”) pan where it was dried using a heat-gun.

After grinding with a mortar and pestle, the resulting particles were screened to −70 mesh (i.e., less than 212 micrometers). A portion of the particles were fed into a hydrogen/oxygen torch flame as described above for Examples 1-3, except for the inner ring, the hydrogen flow rate was 8 standard liters per minute (SLPM), and the oxygen flow rate was 3 SLPM; and for the outer ring, the hydrogen flow rate was 23 standard liters per minute (SLPM), and the oxygen flow rate was 9.8 SLPM. The particles were fed directly into the hydrogen torch flame, where they were melted and transported to an inclined stainless steel surface (about 20 inches wide with the slope angle of 45 degrees) with cold water running over (about 8 l/min.).

About 50 grams of the resulting beads was placed in a graphite die and hot-pressed using uniaxial pressing apparatus (obtained under the trade designation “HP-50”, Thermal Technology Inc., Brea, Calif.). The hot-pressing was carried out at 960° C. in argon atmosphere and 2 ksi (13.8 MPa) pressure. The resulting translucent disk was about 48 mm in diameter, and about 5 mm thick. Additional hot-press runs were performed to make additional disks.

Rectangular bars (about 8×4×2 mm) sectioned from a hot-pressed material were heat-treated for 1 hour under about 1 atmosphere of pressure (i.e., atmospheric pressure) in an electrically heated furnace (obtained from Keith Furnaces of Pico Rivera, Calif.; “Model KKSK-666-3100) at temperatures reported in Table 5, below.

TABLE 5

| Heat-treatment | Hardness, |
|---|---|
| Temperature, ° C. | GPa |
| 900 | 8.4 |
| 1000 | 12.6 |
| 1100 | 13.4 |
| 1200 | 15.1 |
| 1225 | 15.9 |
| 1250 | 16.8 |

The average microhardnesses of Examples 4 materials were measured under a 300-gram indent load as described in Examples 1-3 except that microhardness tester (obtained under the trade designation “MICROMET 4” from Buehler Ltd, Lake Bluff, Ill.) fitted with a Vickers indenter was used. The microhardness measurements are made according to the guidelines stated in ASTM Test Method E384 Test Methods for Microhardness of Materials (1991), the disclosure of which is incorporated herein by reference. The average hardness values (based on an average of 5 measurements) are reported in Table 5, above.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for making ceramic, the method comprising heating a precursor material up to 1250° C. for up to 1 hour under pressure not greater than 500 atmospheres to provide a ceramic comprising at least 35 percent by weight Al₂O₃, based on the total weight of the ceramic, wherein the ceramic has a density of at least 90 percent of theoretical density, wherein the ceramic has an average hardness of at least 15 GPa, and wherein the precursor material does not contain alpha Al₂O₃, alpha Al₂O₃ nucleating agent, or alpha Al₂O₃ nucleating agent equivalent.

2. The method according to the method according to claim 1, wherein the ceramic comprises at least 35 percent by weight alpha Al₂O₃, based on the total weight of the ceramic, and wherein the alpha Al₂O₃ has an average crystal size not greater than 150 nanometers.

3. The method according to the method according to claim 2, wherein the ceramic has x, y, and z dimensions each perpendicular to each other, and wherein each of the x, y, and z dimensions is at least 150 micrometers.

4. The method according to the method according to claim 1, wherein the ceramic comprises at least 60 percent by weight Al₂O₃, based on the total weight of the ceramic.

5. The method according to the method according to claim 4, wherein the ceramic has x, y, and z dimensions each perpendicular to each other, and wherein each of the x, y, and z dimensions is at least 150 micrometers.

6. The method according to the method according to claim 1, wherein the ceramic comprises at least 70 percent by weight Al₂O₃, based on the total weight of the ceramic.

7. The method according to the method according to claim 6, wherein the ceramic has x, y, and z dimensions each perpendicular to each other, and wherein each of the x, y, and z dimensions is at least 150 micrometers.

8. The method according to the method according to claim 1, wherein the ceramic comprises at least 75 percent by weight Al₂O₃, based on the total weight of the ceramic.

9. The method according to the method according to claim 8, wherein the ceramic has x, y, and z dimensions each perpendicular to each other, and wherein each of the x, y, and z dimensions is at least 150 micrometers.

10. The method according to the method according to claim 1, wherein the ceramic has x, y, and z dimensions each perpendicular to each other, and wherein each of the x, y, and z dimensions is at least 150 micrometers.

11. The method according to the method according to claim 10, wherein the heating is up to 1200° C. for up to 1 hour.

12. The method according to the method according to claim 10, wherein the heating is for up to 15 minutes.

13. The method according to the method according to claim 10, wherein the heating is under pressure not greater than 100 atmospheres.

14. The method according to the method according to claim 10, wherein the heating is under pressure not greater than 1.25 atmosphere.

15. The method according to the method according to claim 14, wherein the heating is up to 1200° C. for up to 1 hour.

16. The method according to the method according to claim 14, wherein the heating is up to 15 minutes.

17. The method according to claim 14, wherein the ceramic has an average hardness of at least 16 GPa.

18. The method according to claim 14 wherein the ceramic has an average hardness of at least 17 GPa.

19. The method according to claim 14, wherein the ceramic has an average hardness of at least 18 GPa.

20. The method according to claim 14, wherein the ceramic has a density of at least 95 percent of theoretical density.

21. The method according to claim 1, wherein the wherein the ceramic further comprise a metal oxide other than Al₂O₃ selected from the group consisting of Y₂O₃, REO, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof.

22. The method according to claim 10, wherein the precursor material has an average hardness not more than 10 GPa.

23. The method according to claim 10, wherein the ceramic is at least 85 crystalline, based on the total volume of the ceramic.

24. The method according to claim 1, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume with 70 percent of the precursor material volume.

25. The method according to the method according to claim 1, wherein the heating is under pressure not greater than 100 atmospheres.

26. The method according to the method according to claim 1, wherein the heating is under pressure not greater than 1.25 atmosphere.

27. The method according to claim 26, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 70 percent of the precursor material volume.

28. The method according to claim 27, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 80 percent of the precursor material volume.

29. The method according to claim 27, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 90 percent of the precursor material volume.

30. The method according to the method according to claim 1, wherein the heating is under pressure of about 1 atmosphere.

31. The method according to the method according to claim 1, further comprising providing glass beads, the glass having T_{g};
heating the glass beads above the T_{g} such that the glass beads coalesce to form a shape; and
cooling the coalesced shape to provide the precursor material.

32. The method according to the method according to claim 1, further comprising
providing glass powder, the glass having a T_{g};
heating the glass powder above the T_{g} such that the glass powder coalesces to form a shape;
cooling the coalesced shape to provide the precursor material.

33. The method according to claim 32, wherein the precursor material has a Tₓ, and wherein the heating is conducted at at least one temperature 50° C. greater than the Tₓ.

34. A method for making ceramic, the method comprising heating a precursor material up to 1250° C. for up to 1 hour under pressure not greater than 500 atmospheres to provide a ceramic comprising at least 50 percent by weight alpha Al₂O₃, based on the total weight of the ceramic, wherein the alpha Al₂O₃ has an average crystal size not greater than 150 nanometers, wherein the ceramic has a density of at least 90 percent of theoretical density, wherein the ceramic has an average hardness of at least 15 GPa, and wherein the precursor material contains not more than 30 percent by volume crystalline material, based on the total volume of the precursor material, and wherein the precursor material has a density of at least 70 percent of theoretical density.

35. The method according to the method according to claim 34, wherein the ceramic has x, y, and z dimensions each perpendicular to each other, and wherein each of the x, y, and z dimensions is at least 150 micrometers.

36. The method according to the method according to claim 34, wherein the ceramic comprises at least 60 percent by weight Al₂O₃, based on the total weight of the ceramic.

37. The method according to the method according to claim 36, wherein the ceramic has x, y, and z dimensions each perpendicular to each other, and wherein each of the x, y, and z dimensions is at least 150 micrometers.

38. The method according to the method according to claim 34, wherein the ceramic comprises at least 70 percent by weight Al₂O₃, based on the total weight of the ceramic.

39. The method according to the method according to claim 38, wherein the ceramic has x, y, and z dimensions each perpendicular to each other, and wherein each of the x, y, and z dimensions is at least 150 micrometers.

40. The method according to the method according to claim 34, wherein the ceramic comprises at least 75 percent by weight Al₂O₃, based on the total weight of the ceramic.

41. The method according to the method according to claim 40, wherein the ceramic has x, y, and z dimensions each perpendicular to each other, and wherein each of the x, y, and z dimensions is at least 150 micrometers.

42. The method according to the method according to claim 34, wherein the ceramic has x, y, and z dimensions each perpendicular to each other, and wherein each of the x, y, and z dimensions is at least 150 micrometers.

43. The method according to the method according to claim 34, wherein the heating is up to 1200° C. for up to 1 hour.

44. The method according to the method according to claim 34, wherein the heating is for up to 15 minutes.

45. The method according to the method according to claim 34, wherein the heating is under pressure not greater than 100 atmospheres.

46. The method according to the method according to claim 34 wherein the heating is under pressure not greater than 1.25 atmosphere.

47. The method according to the method according to claim 46, wherein the heating is up to 1200° C. for up to 1 hour.

48. The method according to claim 46, wherein the ceramic has an average hardness of at least 16 GPa.

49. The method according to claim 46 wherein the ceramic has an average hardness of at least 17 GPa.

50. The method according to claim 46, wherein the ceramic has an average hardness of at least 18 GPa.

51. The method according to claim 46, wherein the alpha alumina has a density of at least 95 percent of theoretical density.

52. The method according to claim 34, wherein the wherein the ceramic further comprise a metal oxide other than Al₂O₃ selected from the group consisting of Y₂O₃, REO, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof.

53. The method according to claim 34, wherein the precursor material has an average hardness not more than 10 GPa.

54. The method according to claim 34, wherein the ceramic is at least 85 crystalline, based on the total volume of the ceramic.

55. The method according to claim 34, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume with 70 percent of the precursor material volume.

56. The method according to the method according to claim 34, wherein the heating is under pressure not greater than 100 atmospheres.

57. The method according to the method according to claim 34, wherein the heating is under pressure not greater than 1.25 atmosphere.

58. The method according to claim 57, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 70 percent of the precursor material volume.

59. The method according to claim 57, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 80 percent of the precursor material volume.

60. The method according to claim 57, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 90 percent of the precursor material volume.

61. The method according to the method according to claim 34, wherein the heating is under pressure of about 1 atmosphere.

62. The method according to the method according to claim 34, further comprising
providing glass beads, the glass having T_{g};
heating the glass beads above the T_{g} such that the glass beads coalesce to form a shape; and
cooling the coalesced shape to provide the precursor material.

63. The method according to the method according to claim 34, further comprising
providing glass powder, the glass having a T_{g};
heating the glass powder above the T_{g} such that the glass powder coalesces to form a shape; and
cooling the coalesced shape to provide the precursor material.

64. The method according to claim 34, wherein the precursor material has a Tₓ, and wherein the heating is conducted at at least one temperature 50° C. greater than the Tₓ.

65. A method for making ceramic abrasive particles, the method comprising heating precursor material particles up to 1250° C. for up to 1 hour under pressure not greater than 500 atmospheres to provide ceramic abrasive particles, the ceramic abrasive particles comprising at least 35 percent by weight Al₂O₃, based on the total weight of the respective ceramic abrasive particle, wherein the ceramic has a density of at least 90 percent of theoretical density, wherein the ceramic has an average hardness of at least 15 GPa, and wherein the precursor material particles does not contain alpha Al₂O₃, alpha Al₂O₃ nucleating agent, or alpha Al₂O₃ nucleating agent equivalent.

66. The method according to the method according to claim 65, wherein the ceramic abrasive particles comprise at least 35 percent by weight alpha Al₂O₃, based on the total weight of the respective ceramic abrasive particles, and wherein the alpha Al₂O₃ has an average crystal size not greater than 150 nanometers.

67. The method according to the method according to claim 66, wherein the ceramic abrasive particles have x, y, and z dimensions each perpendicular to each other, and wherein each of the x, y, and z dimensions a respective ceramic abrasive particle is at least 150 micrometers.

68. The method according to the method according to claim 66, wherein the ceramic abrasive particles comprise at least 60 percent by weight Al₂O₃, based on the total weight of the respective ceramic abrasive particle.

69. The method according to the method according to claim 68, wherein the ceramic abrasive particles have x, y, and z dimensions each perpendicular to each other, and wherein each of the x, y, and z dimensions a respective ceramic abrasive particle is at least 150 micrometers.

70. The method according to the method according to claim 66, wherein the ceramic abrasive particles comprise at least 70 percent by weight Al₂O₃, based on the total weight of the respective ceramic abrasive particle.

71. The method according to the method according to claim 70, wherein the ceramic abrasive particles have x, y, and z dimensions each perpendicular to each other, and wherein each of the x, y, and z dimensions a respective ceramic abrasive particle is at least 150 micrometers.

72. The method according to the method according to claim 71, wherein the ceramic abrasive particles comprise at least 70 percent by weight Al₂O₃, based on the total weight of the respective ceramic abrasive particle.

73. The method according to the method according to claim 72, wherein the ceramic abrasive particles have x, y, and z dimensions each perpendicular to each other, and wherein each of the x, y, and z dimensions a respective ceramic abrasive particle is at least 150 micrometers.

74. The method according to the method according to claim 65, wherein the heating is up to 1200° C. for up to 1 hour.

75. The method according to the method according to claim 65, wherein the heating is for up to 15 minutes.

76. The method according to the method according to claim 65, wherein the heating is under pressure not greater than 100 atmospheres.

77. The method according to the method according to claim 65, wherein the heating is under pressure not greater than 1.25 atmosphere.

78. The method according to the method according to claim 77, wherein the heating is up to 1200° C. for up to 1 hour.

79. The method according to the method according to claim 77, wherein the heating is up to 15 minutes.

80. The method according to claim 77, wherein the ceramic abrasive particles have an average hardness of at least 16 GPa.

81. The method according to claim 77 wherein the ceramic abrasive particles have an average hardness of at least 17 GPa.

82. The method according to claim 77, wherein the ceramic abrasive particles have an average hardness of at least 18 GPa.

83. The method according to claim 77, wherein the ceramic abrasive particles have an average hardness of at least 19 GPa.

84. The method according to the method according to claim 77, wherein the heating is conducted in a rotary kiln.

85. The method according to claim 77, wherein the ceramic abrasive particles have a density of at least 95 percent of theoretical density.

86. The method according to claim 65, wherein the wherein the ceramic abrasive particles further comprise a metal oxide other than Al₂O₃ selected from the group consisting of Y₂O₃, REO, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof.

87. The method according to claim 65, wherein the precursor material particles have an average hardness not more than 10 GPa.

88. The method according to claim 65, wherein further comprises grading the abrasive particles to provide a plurality of particles having a specified nominal grade.

89. A method for making an abrasive article, wherein the method according to claim 65 further comprises incorporating the ceramic abrasive particles into an abrasive article.

90. The method according to claim 89, wherein the abrasive article is a bonded abrasive article, a non-woven abrasive article, or a coated abrasive article.

91. The method according to the method according to claim 65, further comprising
providing glass beads, the glass having T_{g};
heating the glass beads above the T_{g} such that the glass beads coalesce to form a shape;
cooling the coalesced shape to provide precursor material; and
crushing the precursor material to provide the precursor material particles.

92. The method according to the method according to claim 65, further comprising
providing glass powder, the glass having a T_{g};
heating the glass powder above the T_{g} such that the glass powder coalesces to form a shape;
cooling the coalesced shape to provide precursor material; and
crushing the precursor material to provide the precursor material particles.

93. The method according to claim 65, wherein the precursor material has a Tₓ, and wherein the heating is conducted at at least one temperature 50° C. greater than the Tₓ.

94. A method for making ceramic abrasive particles, the method comprising heating precursor material particles up to 1250° C. for up to 1 hour under pressure not greater than 500 atmospheres to provide ceramic abrasive particles, the ceramic abrasive particles comprising at least 50 percent by weight alpha Al₂O₃, based on the total weight of the respective ceramic abrasive particle, wherein the alpha Al₂O₃ has an average crystal size not greater than 150 nanometers, wherein the ceramic has a density of at least 90 percent of theoretical density, wherein the ceramic has an average hardness of at least 15 GPa, and wherein the precursor material particles contain not more than 30 percent by volume crystalline material, based on the total volume of the respective precursor material particle, and wherein the precursor material particles have a density of at least 70 percent of theoretical density of the respective precursor material particle.

95. The method according to the method according to claim 94, wherein the ceramic abrasive particles have x, y, and z dimensions each perpendicular to each other, and wherein each of the x, y, and z dimensions a respective ceramic abrasive particle is at least 150 micrometers.

96. The method according to the method according to claim 95, wherein the ceramic abrasive particles comprise at least 60 percent by weight Al₂O₃, based on the total weight of the respective ceramic abrasive particle.

97. The method according to the method according to claim 96, wherein the ceramic abrasive particles have x, y, and z dimensions each perpendicular to each other, and wherein each of the x, y, and z dimensions a respective ceramic abrasive particle is at least 150 micrometers.

98. The method according to the method according to claim 95, wherein the ceramic abrasive particles comprise at least 70 percent by weight Al₂O₃, based on the total weight of the respective ceramic abrasive particle.

99. The method according to the method according to claim 98, wherein the ceramic abrasive particles have x, y, and z dimensions each perpendicular to each other, and wherein each of the x, y, and z dimensions a respective ceramic abrasive particle is at least 150 micrometers.

100. The method according to the method according to claim 99, wherein the ceramic abrasive particles comprise at least 70 percent by weight Al₂O₃, based on the total weight of the respective ceramic abrasive particle.

101. The method according to the method according to claim 100, wherein the ceramic abrasive particles have x, y, and z dimensions each perpendicular to each other, and wherein each of the x, y, and z dimensions a respective ceramic abrasive particle is at least 150 micrometers.

102. The method according to the method according to claim 95, wherein the heating is up to 1200° C. for up to 1 hour.

103. The method according to the method according to claim 95, wherein the heating is for up to 15 minutes.

104. The method according to the method according to claim 95, wherein the heating is under pressure not greater than 100 atmospheres.

105. The method according to the method according to claim 95, wherein the heating is under pressure not greater than 1.25 atmosphere.

106. The method according to the method according to claim 105, wherein the heating is up to 1200° C. for up to 1 hour.

107. The method according to claim 105, wherein the ceramic abrasive particles have an average hardness of at least 16 GPa.

108. The method according to claim 105 wherein the ceramic abrasive particles have an average hardness of at least 17 GPa.

109. The method according to claim 105, wherein the ceramic abrasive particles have an average hardness of at least 18 GPa.

110. The method according to the method according to claim 105, wherein the heating is conducted in a rotary kiln.

111. The method according to claim 105, wherein the abrasive particles have a density of at least 95 percent of theoretical density.

112. The method according to claim 94, wherein the wherein the ceramic abrasive particles further comprise a metal oxide other than Al₂O₃ selected from the group consisting of Y₂O₃, REO, BaO, CaO, Cr₂O₃, CoO, Fe₂O₃, GeO₂, HfO₂, Li₂O, MgO, MnO, NiO, Na₂O, Sc₂O₃, SrO, TiO₂, ZnO, ZrO₂, and combinations thereof.

113. The method according to claim 94, wherein the precursor material particles have an average hardness not more than 10 GPa.

114. The method according to claim 94, wherein further comprises grading the glass-ceramic abrasive particles to provide a plurality of particles having a specified nominal grade.

115. A method for making an abrasive article, wherein the method according to claim 94 further comprises incorporating the ceramic abrasive particles into an abrasive article.

116. The method according to claim 115, wherein the abrasive article is a bonded abrasive article, a non-woven abrasive article, or a coated abrasive article.

117. The method according to the method according to claim 94, wherein the heating is under pressure of about 1 atmosphere.

118. The method according to the method according to claim 94, further comprising
providing glass beads, the glass having T_{g};
heating the glass beads above the T_{g} such that the glass beads coalesce to form a shape;
cooling the coalesced shape to provide precursor material; and
crushing the precursor material to provide the precursor material particles.

119. The method according to the method according to claim 94, further comprising
providing glass powder, the glass having a T_{g};
heating the glass powder above the T_{g} such that the glass powder coalesces to form a shape;
cooling the coalesced shape to provide precursor material; and
crushing the precursor material to provide the precursor material particles.

120. The method according to claim 94, wherein the precursor material has a Tₓ, and wherein the heating is conducted at at least one temperature 50° C. greater than the Tₓ.

121. A method for making ceramic abrasive particles, the method comprising:
heating precursor material up to 1250° C. for up to 1 hour under pressure not greater than 500 atmospheres to provide ceramic, the ceramic comprising at least 35 percent by weight alpha Al₂O₃, based on the total weight of the ceramic, wherein the ceramic has a density of at least 90 percent of theoretical density, wherein the ceramic has an average hardness of at least 15 GPa, and wherein the precursor material does not contain either alpha Al₂O₃ seeds or and alpha Al₂O₃ nucleating agent equivalent; and
crushing the ceramic to provide ceramic abrasive particles.

122. The method according to the method according to claim 121, wherein the ceramic comprises at least 35 percent by weight alpha Al₂O₃, based on the total weight of the ceramic, and wherein the alpha Al₂O₃ has an average crystal size not greater than 150 nanometers.

123. The method according to the method according to claim 122, wherein the ceramic has x, y, and z dimensions each perpendicular to each other, and wherein each of the x, y, and z dimensions is at least 150 micrometers.

124. The method according to the method according to claim 122, wherein the ceramic comprises at least 60 percent by weight Al₂O₃, based on the total weight of the ceramic.

125. The method according to the method according to claim 124, wherein the ceramic has x, y, and z dimensions each perpendicular to each other, and wherein each of the x, y, and z dimensions is at least 150 micrometers.

126. The method according to the method according to claim 121, wherein the ceramic comprises at least 70 percent by weight Al₂O₃, based on the total weight of the ceramic.

127. The method according to the method according to claim 126, wherein the ceramic has x, y, and z dimensions each perpendicular to each other, and wherein each of the x, y, and z dimensions is at least 150 micrometers.

128. The method according to the method according to claim 121, wherein the ceramic comprises at least 75 percent by weight Al₂O₃, based on the total weight of the ceramic.

129. The method according to the method according to claim 128, wherein the ceramic has x, y, and z dimensions each perpendicular to each other, and wherein each of the x, y, and z dimensions is at least 150 micrometers.

130. The method according to the method according to claim 121, wherein the ceramic has x, y, and z dimensions each perpendicular to each other, and wherein each of the x, y, and z dimensions is at least 150 micrometers.

131. The method according to the method according to claim 121, wherein the heating is up to 1200° C. for up to 1 hour.

132. The method according to the method according to claim 121, wherein the heating is for up to 15 minutes.

133. The method according to the method according to claim 121, wherein the heating is under pressure not greater than 100 atmospheres.

134. The method according to the method according to claim 121, wherein the heating is under pressure not greater than 1.25 atmosphere.

135. The method according to claim 121 wherein the ceramic has an average hardness of at least 17 GPa.

136. The method according to claim 121, wherein the ceramic has an average hardness of at least 18 GPa.

137. The method according to claim 121, wherein the precursor material has an average hardness not more than 10 GPa.

138. The method according to claim 121, further comprises grading the ceramic abrasive particles to provide a plurality of abrasive particles having a specified nominal grade.

139. A method for making an abrasive article, wherein the method according to claim 121 further comprises incorporating the ceramic abrasive particles into an abrasive article.

140. The method according to claim 139, wherein the abrasive article is a bonded abrasive article, a non-woven abrasive article, or a coated abrasive article.

141. The method according to claim 121, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 70 percent of the precursor material volume.

142. The method according to claim 121, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 80 percent of the precursor material volume.

143. The method according to claim 121, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 90 percent of the precursor material volume.

144. The method according to the method according to claim 121, wherein the he heating is under pressure of about 1 atmosphere.

145. The method according to claim 121, wherein the precursor material has a Tₓ, and wherein the heating is conducted at at least one temperature 50° C. greater than the Tₓ.

146. A method for making ceramic abrasive particles, the method comprising:
heating precursor material up to 1250° C. for up to 1 hour under pressure not greater than 500 atmospheres to provide ceramic, the ceramic comprising at least 50 percent by weight alpha Al₂O₃, based on the total weight of the ceramic, wherein the alpha Al₂O₃ has an average crystal size not greater than 150 nanometers, wherein the ceramic has a density of at least 90 percent of theoretical density, wherein the ceramic has an average hardness of at least 15 GPa, and wherein the precursor material contains not more than 30 percent by volume crystalline material, based on the total volume of the precursor material, and wherein the precursor material has a density of at least 70 percent of theoretical density of the precursor material; and
crushing the ceramic to provide ceramic abrasive particles.

147. The method according to the method according to claim 146, wherein the ceramic has x, y, and z dimensions each perpendicular to each other, and wherein each of the x, y, and z dimensions is at least 150 micrometers.

148. The method according to the method according to claim 147, wherein the ceramic comprises at least 60 percent by weight Al₂O₃, based on the total weight of the ceramic.

149. The method according to the method according to claim 148, wherein the ceramic has x, y, and z dimensions each perpendicular to each other, and wherein each of the x, y, and z dimensions is at least 150 micrometers.

150. The method according to the method according to claim 147, wherein the ceramic comprises at least 70 percent by weight Al₂O₃, based on the total weight of the ceramic.

151. The method according to the method according to claim 150, wherein the ceramic has x, y, and z dimensions each perpendicular to each other, and wherein each of the x, y, and z dimensions is at least 150 micrometers.

152. The method according to the method according to claim 147, wherein the ceramic comprises at least 75 percent by weight Al₂O₃, based on the total weight of the ceramic.

153. The method according to the method according to claim 152, wherein the ceramic has x, y, and z dimensions each perpendicular to each other, and wherein each of the x, y, and z dimensions is at least 150 micrometers.

154. The method according to the method according to claim 147, wherein the ceramic has x, y, and z dimensions each perpendicular to each other, and wherein each of the x, y, and z dimensions is at least 150 micrometers.

155. The method according to the method according to claim 147 wherein the heating is up to 1200° C. for up to 1 hour.

156. The method according to the method according to claim 147, wherein the heating is for up to 15 minutes.

157. The method according to the method according to claim 147, wherein the heating is under pressure not greater than 100 atmospheres.

158. The method according to the method according to claim 147, wherein the heating is under pressure not greater than 1.25 atmosphere.

159. The method according to claim 158 wherein the ceramic has an average hardness of at least 17 GPa.

160. The method according to claim 154, wherein the ceramic has an average hardness of at least 18 GPa.

161. The method according to claim 147, wherein the precursor material has an average hardness not more than 10 GPa.

162. The method according to claim 147, further comprises grading the ceramic abrasive particles to provide a plurality of abrasive particles having a specified nominal grade.

163. A method for making an abrasive article, wherein the method according to claim 147 further comprises incorporating the ceramic abrasive particles into an abrasive article.

164. The method according to claim 163, wherein the abrasive article is a bonded abrasive article, a non-woven abrasive article, or a coated abrasive article.

165. The method according to claim 147, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 70 percent of the precursor material volume.

166. The method according to claim 147, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 80 percent of the precursor material volume.

167. The method according to claim 147, wherein the precursor material has an x, y, z direction, each of which has a length of at least 1 cm, wherein the precursor material has a volume, wherein the resulting ceramic has an x, y, z direction, each of which has a length of at least 1 cm, wherein the ceramic has a volume of at least 90 percent of the precursor material volume.

168. The method according to the method according to claim 147, wherein the heating is under pressure of about 1 atmosphere.

169. The method according to claim 147, wherein the precursor material has a Tₓ, and wherein the heating is conducted at at least one temperature 50° C. greater than the Tₓ.
